(19) United States
(12) Patent Application Publication
(10) Pub. No.: US 2025/0022212 A1
(43) Pub. Date: Jan. 16, 2025

(54) RENDERING 3D SCENE COMPRISING OBJECTS

(71) Applicants: KONINKLIJKE KPN N.V., Rotterdam (NL); NEDERLANDDSE ORGANISATIE VOOR TOEGEPAST-NATUURWETENSCHAPPELIJK ONDERZOEK TNO, DA 'S Gravenhage (NL)

(72) Inventors: Aschwin Steven Reinier Brandt, The Hague (NL); Emmanouil Potetsianakis, The Hague (NL)

(21) Appl. No.: 18/708,973

(22) PCT Filed: Nov. 28, 2022
(86) PCT No.: PCT/EP2022/083430

§ 371 Date: May 9, 2024

(30) Foreign Application Priority Data
Dec. 2, 2021 (EP) 21211892.1

(51) Int. Cl. G06T 15/20; G06T 3/16; G06T 7/55; G06T 7/70; G06T 19/00

(52) U.S. Cl. CPC G06T 15/20; G06T 3/16; G06T 7/55; G06T 7/70; G06T 19/003; G06T 2200/16; G06T 2210/08

(57) ABSTRACT

A client device may be enabled to render a three-dimensional [3D] scene comprising one or more objects. At a server system, a video-based representation of an object may be streamed as one or more video streams to the client device. At the client device, the scene may be rendered from a viewing position within the scene to obtain a rendered view of the scene. Furthermore, a relative position between the viewing position and a position of the object in the scene may be determined. At the server system, the one or more video streams may be generated to show the object from a limited set of viewing angles, wherein the limited set of viewing angles is selected based on the relative position. At the client device, a viewing angle may be selected from the limited set of viewing angles and the video-based representation of the object may be placed at said selected viewing angle in the scene.

### TECHNICAL FIELD

The invention relates to a computer-implemented method of, and a system configured for, enabling a client device to render a three-dimensional [3D] scene comprising one or more objects. The invention further relates to a computer-implemented method of, and a client device configured for, rendering a 3D scene comprising one or more objects. The invention further relates to a computer-readable medium comprising data representing instructions for a computer program.

### BACKGROUND

It is known to enable a user to view a scene using computer-based rendering techniques. For example, in Virtual Reality (VR), Augmented Reality (AR) or Mixed Reality (MR), together referred to as ‘Extended Reality (XR)’, a user may be enabled to view a scene using a head-mounted display. Such a scene may be entirely computer-rendered, e.g., in the case of VR, but may also be a hybrid scene which combines computer-based imagery with the physical reality, e.g., in the case of AR and MR. In general, a scene which may be rendered by a client device may be based on computer graphics, e.g., with objects defined as vertices, edges and faces, but also based on video and as well as a combination of the computer-graphics and video.

For example, it is known to capture a panoramic video of a real-life scene and to display the panoramic video to a user. Here, the adjective ‘panoramic’ may refer to the video providing an immersive experience when displayed to the user. One may for example consider a video to be ‘panoramic’ if it provides a wider field of view than that of the human eye (being about 160° horizontally by 75° vertically). A panoramic video may even provide a larger view of the scene, e.g., a full 360 degrees, thereby providing an even more immersive experience to the user. Such panoramic videos may be acquired of a real-life scene by a camera, such as a 180° or 360° camera, or may be synthetically generated (‘3D rendered’) as so-called Computer-Generated Imagery (CGI). Panoramic videos are also known as (semi-) spherical videos. Videos which provide at least an 180° horizontal and/or 180° vertical view are also known as ‘omnidirectional’ videos. An omnidirectional video is thus a type of panoramic video.

It is known to acquire different panoramic videos of a scene. For example, different panoramic videos may be captured at different spatial positions within the scene. Each spatial position may thus represent a different viewpoint within the scene. An example of a scene is an interior of a building, or an outdoor location such as a beach or a park. A scene may also be comprised of several locations, e.g., different rooms and/or different buildings, or a combination of interior and exterior locations.

It is known to enable a user to select between the display of the different viewpoints. Such selection of different viewpoints may effectively allow the user to ‘teleport’ through the scene. If the viewpoints are spatially in sufficient proximity, and/or if a transition is rendered between the different viewpoints, such teleportation may convey the user with a sense of near-continuous motion through the scene.

Such panoramic videos may be streamed from a server system to a client device in the form of video streams. For example, reference [1] describes a multi-viewpoint (MVP) 360-degree video streaming system, where a scene is simultaneously captured by multiple omnidirectional video cameras. The user can only switch positions to predefined viewpoints (VPs). The video streams may be encoded and streamed using MPEG Dynamic Adaptive Streaming over HTTP (DASH), in which multiple representations of content may be available at different bitrates and resolutions.

A problem of reference [1] is that predefined viewpoints may be too coarsely distributed within a scene to convey the user with a sense of being able to freely move within the scene. While this may be addressed by increasing the number of predefined viewpoints at which the scene is simultaneously captured, this requires a great number of omnidirectional video cameras and poses many practical challenges, such as cameras obstructing parts of the scene. It is also known to synthesize viewpoints, for example from reference [2]. However, viewpoint synthesis is computationally intensive and may thus pose a severe computational burden when used to synthesize panoramic videos, either on a client device when the viewpoint synthesis is performed at the client device (which may require the viewpoint synthesis to use a relatively low resolution, as in [2]) or on a server system when simultaneously synthesizing a number of viewpoints.

Moreover, even if viewpoints are distributed at a sufficiently fine granularity within the scene, if a client device ‘moves’ through the scene (e.g., by the client rendering the scene from successive viewing positions within the scene), the client device may have to rapidly switch between the respective video streams. To avoid latency during the movement due to the client device having to request a new video stream, the client device may request and receive multiple video streams simultaneously, e.g., of a current viewing position and of adjacent viewing positions within the scene, so as to be able to (more) seamlessly switch between the video streams. However, such simultaneously video streams require a great amount of bandwidth between the server system and the client device, but also place a high burden on other resources of, for example, the client device (decoding, buffering, etc.).

### REFERENCES

[1] Xavier Corbillon, Francesca De Simone, Gwendal Simon, and Pascal Frossard. 2018. Dynamic adaptive streaming for multi-viewpoint omnidirectional videos. In Proceedings of the 9th ACM Multimedia Systems Conference (MMSys '18). Association for Computing Machinery, New York, NY, USA, 237-249.
[2] Attal B., Ling S., Gokaslan A., Richardt C., Tompkin J. (2020) MatryODShka: Real-time 6 DoF Video View Synthesis Using Multi-sphere Images. In Computer Vision-ECCV 2020. ECCV 2020. Lecture Notes in Computer Science, vol 12346. Springer, Cham. https://doi.org/10.1007/978-3-030-58452-8_26

### SUMMARY

The following aspects of the invention may be based on the recognition that changes in viewing position in a scene may not affect each object in a scene equally. Namely, changes in viewing position may result in a change in the perspective at which objects in the scene are shown, i.e., the orientation and scale of objects. However, the change in perspective may not be equal for all objects, in that objects nearby the viewing position may be subject to greater changes in perspective than objects far way. Similarly, the change in perspective may not be visible in all objects equally, e.g., due to the object's appearance (e.g., a change in perspective of an object with fewer spatial detail may be less visible than one in an object with more spatial detail) or due to the cognitive effects or considerations (e.g., objects representing persons may attract greater attention than non-human objects). There may thus be a need to allow a client device to accommodate changes in viewing position on a per-object basis, so as to avoid having to stream an entire panoramic video to accommodate each change.

In a first aspect of the invention, a computer-implemented method may be provided of enabling a client device to render a three-dimensional [3D] scene comprising one or more objects. The method may comprise:
at a server system, streaming a video-based representation of an object as one or more video streams to the client device;
at the client device, rendering the scene from a viewing position within the scene to obtain a rendered view of the scene, wherein the rendering of the scene may comprise placing the video-based representation of the object at an object position within the scene;
wherein the method may further comprise:
determining a relative position between the viewing position and the object position;
at the server system, generating the one or more video streams to show the object from a limited set of viewing angles, wherein the limited set of viewing angles may be selected based on the relative position; and
at the client device, selecting a viewing angle from the limited set of viewing angles and placing the video-based representation of the object at said selected viewing angle in the scene.

In a further aspect of the invention, a computer-implemented method may be provided for, at a server system, streaming a video-based representation of an object as one or more video streams to a client device. The method may comprise:
determining a relative position between a viewing position, from which viewing position the client device renders the scene, and an object position, at which object position the video-based representation of the object may be placed within the scene; and generating the one or more video streams to show the object from a limited set of viewing angles, wherein the limited set of viewing angles may be selected based on the relative position.

In a further aspect of the invention, a server system may be provided for streaming a video-based representation of an object as one or more video streams to a client device. The server system may comprise:
a network interface to a network;
a processor subsystem configured to:
   determine a relative position between a viewing position, from which viewing position the client device renders the scene, and an object position, at which object position the video-based representation of the object may be placed within the scene; and
   generate the one or more video streams to show the object from a limited set of viewing angles, wherein the limited set of viewing angles may be selected based on the relative position.

In a further aspect of the invention, a computer-implemented method may be provided of, at a client device, rendering a three-dimensional [3D] scene comprising one or more objects. The method may comprise:
from a streaming system and via the network, receiving one or more video streams comprising a video-based representation of an object;
rendering the scene from a viewing position within the scene to obtain a rendered view of the scene, wherein the rendering of the scene may comprise placing the video-based representation of the object at an object position within the scene;
wherein the method may further comprise:
determining a relative position between the viewing position and the object position;
providing metadata indicative of the relative position to the server system to cause the server system to generate the one or more video streams to show the object from a limited set of viewing angles, wherein the limited set of viewing angles may be selected based on the relative position; and
selecting a viewing angle from the limited set of viewing angles and place the video-based representation of the object in accordance with said selected viewing angle in the scene.

In a further aspect of the invention, a client device may be provided for rendering a three-dimensional [3D] scene comprising one or more objects. The client device may comprise:
a network interface to a network;
a processor subsystem configured to:
   from a streaming system and via the network, receive one or more video streams comprising a video-based representation of an object;
   render the scene from a viewing position within the scene to obtain a rendered view of the scene, wherein the rendering of the scene may comprise placing the video-based representation of the object at an object position within the scene;
   wherein the processor subsystem may be further configured to:
      determine a relative position between the viewing position and the object position;
      provide metadata indicative of the relative position to the server system to cause the server system to generate the one or more video streams to show the object from a limited set of viewing angles, wherein the limited set of viewing angles may be selected based on the relative position; and
      select a viewing angle from the limited set of viewing angles and place the video-based representation of the object in accordance with said selected viewing angle in the scene.

In a further aspect of the invention, a system may be provided for enabling a client device to render a three-dimensional [3D] scene comprising one or more objects. The system may comprise the client device and the server system.

In a further aspect of the invention, a transitory or non-transitory computer-readable medium may be provided. The computer-readable medium may comprise data representing a computer program. The computer program may comprise instructions for causing a processor system to perform any of the above methods.

The above measures may essentially involve a streaming server generating and streaming one or more video streams to a client device, which one or more video streams May show an object from a limited set of viewing angles, to enable the client device to, when changing viewing position, accommodate the change in perspective of the object based on the video data contained in these one or more video streams.

In particular, a server system may be provided which may be configured to stream a video-based representation of an object as one or more video streams to the client device. Such streaming may for example take place via a network, such as the Internet, or a combination of an access network and the Internet, or a content delivery network defined as a virtual network on top of a physical network infrastructure, etc. The term ‘video-based representation’ may refer to the object being shown in the video stream(s) in the form of pixels, voxels, or the like, and may thereby distinguish from representations of objects as pure computer graphics, e.g., defined as vertices, edges and faces. The object may for example be shown in one video stream, or two or more video streams together may show the object, as also elucidated elsewhere. It will be appreciated that the following may, for sake of explanation, also simply refer to ‘a’ or ‘the’ video stream as comprising the video-based representation(s) of the object, instead of referring to ‘one or more’ video streams. It will be appreciated, however, that any such references do not preclude a distribution over two or more video streams.

At the client device, a three-dimensional [3D] scene may be rendered (which may also be simply referred to as ‘scene’). The scene may for example comprise three spatial dimensions, e.g., X, Y and Z. By being a 3D scene, the client device may render the scene from different viewing positions within the scene, which viewing positions may likewise be defined in the three spatial dimensions. In some examples, the client device may render the scene from a viewing position and using a viewing direction. For example, the scene may be rendered from a viewing position and viewing direction, while rendering only the part of the scene within a particular field-of-view. Such rendering may also be referred to as ‘rendering using a virtual camera’ or ‘rendering of a viewport’. Accordingly, only part of the scene may be rendered which may be visible from the virtual camera or within the viewport.

3D scenes of the type described in the previous paragraph may be known per se, with a 3D scene being typically defined using 3D coordinates. In general, a 3D scene may comprise objects in various forms, for example objects defined as computer graphics, as video and/or as a combination of computer graphics and video. In some examples, computer graphics-based objects may by themselves not be apparent in the scene, but may rather be used to enable videos to be shown in the 3D scene. For example, in the earlier example of a scene which has different viewpoints at which panoramic videos are available, the video data of a panoramic video may be shown as a texture on an interior of a sphere surrounding a viewpoint, with the sphere being defined as computer graphics. Accordingly, a computer graphics-based object may define a canvas or ‘virtual display’ for the display of a video within the 3D scene.

The 3D scene may be rendered by the client device using known rendering techniques, such as rasterization or raytracing, and using its CPU(s) and/or GPU(s), to obtain a rendered version of the part of the scene. Such a rendered version may take various forms, such as an image or a video, which may be represented in 2D, in volumetric 3D, in stereoscopic 3D, as a point-cloud, etc., and which image or video may be displayed, but in some examples, also recorded or further transmitted, e.g., in encoded form to yet another device. In some examples, the rendered version may also take another form besides an image or video, such as an intermediary rendering result representing the output of one or more steps of a client device's rendering pipeline.

The 3D scene to be rendered by the client device may at least comprise the object of which the video-based representation is received by streaming. In some examples, the scene may comprise further objects, which further objects may also be streamed as video-based representations by the streaming server, or may be based on computer graphics, or may comprise a combination of objects based on computer graphics and objects based on video. In some examples, the scene may, in addition to one or more individual objects, also comprise a panoramic video which may show a sizable part of the scene outside of the individual objects. For example, the panoramic video may represent a background of the scene and the one or more objects may represent foreground objects in relation to the background. In such examples, there may exist a number of panoramic videos at a number of viewpoints within the scene. In yet other examples, the scene may be an augmented reality or mixed reality scene in which the video-based representation of the object is combined with a real-life scene, which may for example be displayed by the client device using a real-time recording of the external environment of the client device, or in case the scene is viewed by a user using a head-mounted display, through a (partially) transparent portion of the display.

The client device may be configured to, when rendering the scene, placing the video-based representation of the object at a position within the scene, which position is elsewhere also referred to as ‘object position’. The position may for example be a predefined position, e.g., as defined by scene metadata, and may be a static position or a dynamic position (e.g., the object may be predefined to move within the scene). However, the object position may not need to be predefined. For example, if the object represents an avatar of another user in a multi-user environment, the object position may be under control of the other user and thereby not predefined. In general, the object position may be a 3D position, e.g., in X, Y, Z, but may also be a 2D position, e.g., in X, Y, e.g., if all objects are placed at a same Z-position. By rendering the scene from the viewing position within the scene, the video-based representation of the object may be shown in the rendered view when the object is visible from the viewing position.

The above measures may further involve, at the server system, generating the one or more video streams to show the object from a limited set of viewing angles. For example, the one or more video streams may together comprise different video-based representations of the object, with each video-based representation showing the object from a different viewing angle. The above may be further explained as follows: the object may be a 3D object which may in principle be viewed from different angles, with such angles being also referred to as ‘viewing angles’. Thus a viewing angle may provide the angle from which a view of the object is provided or needs to be provided. A viewing angle may for example be an azimuth angle in the XY plane (e.g., when assuming a constant polar angle in the XYZ space), or a combination of polar and azimuth angles in the XYZ space. Depending on the viewing angle, the perspective of the object may change, e.g., which parts of the object are visible and which parts are not visible, as well as the perspective of the visible parts in relation to each other. At the server system, it may be possible to show the object in the video-based representation of the object, i.e., in the video stream(s), from a particular viewing angle by the object being available to the server system in a 3D format, for example by the object being originally defined as computer graphics or as a volumetric video, or by a particular viewing angle being synthesizable, e.g., from different video recording which are available of the object.

The server system may thus generate the video-based representation of the object in accordance with a desired viewing angle. The viewing angle may for example be chosen to match the viewing position of the client device within the scene. For that purpose, a relative position may be determined between the object position and the viewing position. For example, the relative position may be determined as a geometric difference between both positions, and may thus take the form of a vector, e.g., pointing from the object position to the viewing position or the other way around. The relative position may thus indicate from which side the object is viewed from the viewing position within the scene. This information may be taken into account, e.g., by the server system, to generate the video-based representation of the object to show the object from the perspective at which the object is viewed from the viewing position within the scene. In some embodiments, the orientation of the object within the scene may be taken into account, in that not only the relative position to the object, but also the absolute orientation of the object within the scene, may together determine from which side the object is viewed from the viewing position within the scene. In other examples, the object orientation may be implicitly instead of explicitly taken into account, e.g., when synthesizing the object from different panoramic videos acquired at different viewpoints within the scene, in which case the object orientation may not need to be explicitly available to the server system but may be correctly accommodated by taking into account the positions of the different viewpoints in the view synthesis.

In accordance with the above measures, the server system may not solely create a video-based representation of the object for a particular viewing angle, e.g., at which the object is currently visible within the scene, but for a limited set of viewing angles, which may for example extend angularly to both sides of a current viewing angle (e.g., 45°+/−10° at 1° increments, resulting in 20 viewing angles) or which in some embodiments may be off-centered (e.g., 45°, extending −15° and +5° at 2° increments, resulting in 10 viewing angles) or selected in any other way. The set of viewing angles may for example be limited in range, e.g., being a sub-range of the range [0, 360°], e.g., limited to a width of maximum 5°, 10°, 20°, 25°, 45°, 90°, 135°, 180° etc., and/or the granularity of viewing angles in the set being limited, e.g., to every 1°, 2°, 3°, 4°, 5°, 6°, 8°, 12°, 16°, etc. In this respect, it is noted that the distribution of viewing angles within the set may be regular but also irregular, e.g., being more coarsely distributed at the boundary of the range and more finely centrally in the range. In general, the limited set of viewing angles may include at least 3 viewing angles.

In some examples, the viewing angle which may geometrically follow from the relative position to the object (and which may in this paragraph be referred to as ‘particular viewing angle’) may be included as a discrete viewing angle within the limited set of viewing angles, while in other examples, the limited set of viewing angles may define a range which may include the particular viewing angle in that said angle falls within the range but is not included as a discrete element in the limited set of viewing angles. In yet other examples, the limited set of viewing angles may be selected based on the particular viewing angle but without including the particular viewing angle, for example if it is predicted that the relative position is subject to change. At the client device, when receiving the video stream(s), a viewing angle may be selected from the limited set of viewing angles and the video-based representation of the object may be placed at said selected viewing angle in the scene, for example by selecting a particular video-based representation from the one or more video streams.

The above measures may therefore result in one or more video streams being streamed to the client device, which video stream(s) may show an object from a limited set of viewing angles, to enable the client device to, when changing viewing position, accommodate the change in perspective of the object based on the video data contained in the video stream(s). Namely, if the perspective of the object changes, e.g., due to changes in the viewing position, which may for example be rapid and/or unexpected, the client device may select the appropriate viewing angle from the one or more video streams, without having to necessarily request the server system to adjust the video stream(s) and without having necessarily to await a response in form of adjusted video stream(s). Due to the latency between the client device and the server system, such a request may otherwise take some time to be effected, which may result in the perspective of the object not changing despite a change in viewing position, or the client device being unable to accommodate a request to change viewing position.

An advantage of the above measures may thus be that the client device may be more responsive to changes in viewing position, in that it may not need to request adjustment of the video stream(s) in case the viewing angle at the changed viewing position is already included in the limited set of viewing angles at which the object is shown in the currently streamed video stream(s). In addition, the above measures may provide a visual representation of an object, instead of the entire scene. This may allow, when the viewing position changes, to accommodate the change in perspective in the scene only for select object(s), or differently for different objects. For example, nearby objects or objects of particular interest, for which a change in perspective is or is expected to be more visible, may be shown at a range of viewing angles with a finer granularity to be able to respond to smaller changes in viewing position, while faraway objects or objects of lesser interest may be shown at a range of viewing angles with a coarser granularity, e.g., resulting in an object being shown at fewer viewing angles or only a single viewing angle. Moreover, by streaming visual representations of individual objects, the client device may be responsive to changes in viewing position without having to request and subsequently receive, decode, buffer, etc. an entire panoramic video for the changed viewing position. Compared to the latter scenario, this may result in a reduction in bandwidth between the server system and the client device, as well as in a reduction of burden on other resources of, for example, the client device (e.g., computational resources for decoding, buffering, etc.).

The following embodiments may represent embodiments of the system for, and corresponding computer-implemented method of, enabling a client device to render a 3D scene comprising one or more objects, but may, unless otherwise precluded for technical reasons, also indicate corresponding embodiments of the streaming system and corresponding computer-implemented method, and embodiments of the client device and corresponding computer-implemented method. In particular, any functionality described to be performed at or by the client device may imply the client device's processor subsystem being configured to perform the respective functionality or the corresponding method to comprise a step of performing the respective functionality. Likewise, any functionality described to be performed at or by the streaming system may imply the streaming system's processor subsystem being configured to perform the respective functionality or the corresponding method to comprise a step of performing the respective functionality. Any functionality described without specific reference to the client device or the streaming system may be performed by the client device or by the streaming system or both jointly.

In an embodiment, the relative position may be representable as a direction and a distance between the viewing position and the object position, and the limited set of viewing angles may be selected based on the direction and/or the distance. The relative position between the object position and the viewing position may be represented by a combination of distance and direction, which may in the following also be referred to as ‘relative distance’ and ‘relative direction’. For example, if the relative position is expressed as a vector, the magnitude of the vector may represent the distance while the orientation of the vector may represent the direction. The limited set of viewing angles may be selected based on either or both the relative distance and the relative direction. Here, “the set of viewing angles being selected’ may refer to one or more parameters defining the set of viewing angles being selected, e.g., the range or granularity or distribution of the viewing angles within the set of viewing angles.

In an embodiment, the limited set of viewing angles may be limited to a set of angles within an interval, wherein the interval may be within a range of possible angles from which the object can be rendered, wherein the position of the interval within the range of possible angles may be selected based on the direction. The set of viewing angles may thus be limited to a sub-range of [0, 360°], or to a sub-range of any other range of viewing angles from which the object could be rendered. This sub-range may here and elsewhere also be referred to as an ‘interval’ within the larger range of possible angles. The position of the interval within the larger range may be selected based on the relative direction. Here, the term ‘position within the interval’ may refer to the offset of the interval within the larger range. For example, an interval having a width of 90° may span the viewing angle interval [90°, 180°] but also the viewing angle interval [180°, 270°]. In a specific example, the interval may be chosen such that the viewing angle which geometrically corresponds to the relative direction to the object is included within the interval. In another specific example, the interval may be centered around, or may be offset with respect to, this viewing angle. In some examples, the position with the interval may be selected based on both the relative direction to the object and on an orientation of the object itself within the scene. As such, it may be taken into account that the object may have a certain orientation within the scene.

In an embodiment, at least one of: a width of the interval, a number of viewing angles within the interval, and a spacing of the viewing angles within the interval, is selected based on the distance. Here, the width of the interval may refer to a width of the sub-range relative to the larger range from which the object could be rendered, while the number and spacing of viewing angles within the interval may elsewhere be characterized by a granularity and distribution of viewing angles. Given a certain absolute change in viewing position within the scene, the distance to the object may indicate the change in perspective of the object experienced at the viewing position, e.g., in terms of the magnitude of the change. Generally speaking, if the distance is small, i.e., if the object is nearby the viewing position, a given change in the viewing position may result in a larger change in the relative direction to the object, e.g., in a larger angular change, than if the distance is large, i.e., if the object is far from the viewing position. To accommodate such a possibly larger change in the relative direction to the object, the interval may be adjusted, for example by choosing a wider interval so as to accommodate these larger changes, or by decreasing the spacing of the viewing angles within interval to accommodate smaller changes already resulting in a visible change in perspective. Generally, the interval may be chosen smaller for a larger distance to the object and may be chosen larger for a smaller distance.

In an embodiment, the relative position may be determined by the client device and signaled to the server system. In another embodiment, the relative position may be determined by the server system, for example if the server system is aware of, or orchestrates, the viewing position of the client device within the scene. In another embodiment, the relative position may be determined by the client device, the limited set of viewing angles may be selected by the client device based on the relative position, and the limited set of viewing angles, or parameters describing the limited set of viewing angles, may be signaled by the client device to the server system.

In an embodiment, at the server system, a spatial resolution, a temporal framerate, or another video quality parameter of the one or more video streams may be adjusted, or initially selected, based on the distance. The visibility of the object may decrease the greater the distance of the object to the viewing position is. Accordingly, video quality of the object within the video stream may be decreased with such a greater distance, e.g., to save bandwidth and/or coding resources. For example, the spatial resolution may be decreased, the temporal frame rate may be decreased, etc.

In an embodiment, a latency may be estimated, wherein the latency may be associated with the streaming of the one or more video streams from the server system to the client device, wherein the limited set of angles may be selected further based on the latency. The latency between the client device in the server system may broadly determine how quickly the server system may react to a change in circumstances at the client device and how quickly the client device may experience results thereof, e.g., by receiving an adjusted video stream. Namely, if the latency is high and if client device informs the server system of a change in viewing position so as to enable the server system to generate the video-based representation of the object for a different set of viewing angles, it may take too long for the adjusted video stream to reach the client device, in that the viewing position may have already changed before the adjusted video stream reaches the client device. To accommodate such latency, the limited set of viewing angles may be selected based at least in part on the latency. For example, for a higher latency, a wider interval and/or an interval which is offset in a certain direction may be selected to enable the client device to cope with a larger change in viewing position based on existing video stream(s). Likewise, for a lower latency, a narrow interval may be selected as the client device may not need to cope with larger changes in viewing position based on the existing video streams but may simply request the server system to adjust the video stream(s) to accommodate the change in viewing position. The latency may be estimated in any suitable manner, e.g., by the client device or by the server system, and may comprise a network latency but also other aspects, e.g., encoding latency at the server system or decoding latency at the client device. In some embodiments, the latency may be estimated as a so-called motion-to-photon latency, as is known per se in the field of Virtual Reality (VR).

In an embodiment, at the client device, the viewing position may be moved within the scene over time, and the limited set of angles may be selected based on a prediction of a change in the relative position due to said movement of the viewing position. The change in viewing position at the client device may be predicted, for example at the client device itself and then signaled to the server system, or at the server system, e.g., based on an extrapolation of metadata which was previously signaled by the client device to the server system. For example, it may already be known which path the viewing position may follow within the scene, or it may be predicted in which direction the viewing position is likely to change, e.g., due to the viewing position within the scene being subjected to simulated physical laws such as inertia, or due to the viewing position being controlled by a user and the user's behavior being predictable, etc. By predicting the movement of the viewing position, it may be predicted at which viewing angle(s) the object is to be shown in the near future. The limited set of viewing angles may thus be selected to include such viewing angles, for example by being selected wide enough or by being offset towards such viewing angles with respect to a current viewing angle. This may enable the client device to cope with a larger change in viewing position based on existing video stream(s), i.e., without having to request the server system to adjust its video stream(s) to reflect the change in viewing position in the set of viewing angles from which the object is shown.

In an embodiment, the movement of the viewing position may be planned to follow a path to a next viewing position in the scene, and the limited set of viewing angles may be selected based on the next viewing position or an intermediate viewing position along the path to the next viewing position. As elucidated elsewhere, if the movement of the viewing position is planned, it may be known when and/or how the viewing position is subject to change. The limited set of viewing angles may be selected to accommodate this change, for example by determining a relative direction between i) the object position and ii) a next viewing position on a path or an intermediate viewing position along the path to the next viewing position.

In an embodiment, at the server system, a panoramic video may be streamed to the client device to serve as a video-based representation of at least part of the scene, and at the client device, the panoramic video may be rendered as a background to the video-based representation of the object. The scene may thus be represented by a combination of one or more panoramic videos and one or more video-based representations of specific objects. As elucidated elsewhere in this specification, such panoramic videos may only be available for a limited set of viewpoints within the scene, and the synthesis of entire panoramic videos at intermediate viewpoints may be computationally complex and, when used to provide a fine granularity of viewpoints, may require multiple synthesized panoramic videos to be streamed in parallel to the client device as the client device may rapidly change between such viewpoints. To avoid such disadvantages, the scene may be represented by a panoramic video, which may not need to be available at a particular viewing position, but which may originate from a nearby viewing position. To nevertheless convey the sense of being at the particular viewing position, objects of interest may be rendered at their correct perspective based on video-based representations of these objects being streamed to the client device and these representations showing the object from a limited set of angles. This may enable the client device to respond to smaller changes in viewing position by selecting a video-based representation of an object at a desired viewing angle from the video stream(s).

In an embodiment, the panoramic video may comprise presentation timestamps, and at the client device, a presentation timestamp may be provided to the server system during playout of the panoramic video, and at the server system, the one or more video streams may be generated to show the object at a temporal state which is determined based on the presentation timestamp. This way, the video-based representation of the object may be synchronized in time, for example in terms of being generated by the server system, streamed to the client device and/or received by the client device, to the play-out of the panoramic video by the client device.

In an embodiment, at the client device:
the scene may be rendered within a viewport, wherein the viewport may be defined by a viewing direction and/or a field of view;
metadata may be provided to the server system, wherein the metadata may be indicative of the viewing direction and/or the field of view;
and at the server system:
a visibility of the object at the client device may be determined based on the metadata and the streaming of the one or more video streams may be controlled based on the visibility.

For example, the video stream(s) may be started to be streamed if the object becomes visible or is expected to become visible within a viewport, or the video stream(s) may be stopped to be streamed if the object becomes invisible or is expected to become invisible by moving out of the viewport. Another example of such control of the streaming based on the object's visibility within the viewport is that the video quality may be adjusted based on the visibility. For example, if an object is partially visible or just outside the viewport, the video stream(s) may be generated to have a lower video quality, e.g., in terms of spatial and/or temporal resolution or encoding quality.

In an embodiment, generating the one or more video streams may comprise generating the one or more video streams to include a set of videos, wherein each of the videos shows the object from a different viewing angle. The video stream(s) may thus be generated to comprise a separate video for each viewing angle. Advantageously, the client device may simply select the appropriate video from the video stream(s), i.e., without requiring a great amount of additional processing. In some examples, each video may be independently decodable, which may avoid the client device having to decode all the videos, thereby saving computational resources.

In an embodiment, generating the one or more video streams may comprises at least one of:
spatially multiplexing the set of videos;
temporally multiplexing the set of videos; and
using a multi-view coding technique to encode the set of videos.

It will be appreciated by those skilled in the art that two or more of the above-mentioned embodiments, implementations, and/or aspects of the invention may be combined in any way deemed useful.

Modifications and variations of any one of the systems or devices (e.g., the system, the streaming system, the client device), computer-implemented methods, metadata and/or computer programs, which correspond to the described modifications and variations of another one of these systems or devices, computer-implemented methods, metadata and/or computer programs, and vice versa, may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows a server system configured to stream a video-based representation of an object as one or more video streams to a client device, wherein the client device is configured to render a scene and as part of the rendering place the video-based representation of the object at an object position within the scene;

FIG. 2 shows different viewing positions within the scene, with the view of the object, and the viewing angle to the object, being different at each viewing position;

FIG. 3 shows a limited set of views of the object from a limited set of viewing angles having been generated for each of the viewing positions of FIG. 2;

FIG. 4 shows the scene comprising a number of pre-rendered viewing areas which each show the scene from a different viewing position, and an intermediate viewing area which is synthesized from one or more of the pre-rendered viewing areas;

FIG. 5 is similar to FIG. 3 but shows the different views of the object to be used to render object on a path between pre-rendered viewing areas;

FIG. 6 shows the alignment between a coordinate system associated with the scene and the range of viewing angles at which the object is shown;

FIG. 7 shows the client device having a field of view within the scene, with the visibility of objects being dependent on whether they are within the field of view;

FIG. 8 illustrates the effect of the distance of the viewing position to the object position for a same type of movement within the scene;

FIG. 9 illustrates the spacing of viewing angles for the limited set of viewing angles at which the object is shown in the one or more video streams; and

FIG. 10 shows a non-transitory computer-readable medium comprising data;

FIG. 11 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### REFERENCE SIGNS LIST

The following list of references and abbreviations is provided for facilitating the interpretation of the drawings and shall not be construed as limiting the claims.
A-D pre-rendered video area
E synthesized video area
O-U object
1-4, 6-9 viewing positions within scene
10 network
20 metadata
30 video stream(s)
100 client device
120 network interface
140 processor subsystem
160 data storage
180 display interface
182 display data
184 sensor data
190 head-mounted display
200 server system
220 network interface
240 processor subsystem
260 data storage
301-307 view of object from viewing position/viewing angle
310 relative position between viewing position and object position
321-323 spatially multiplexed view of object from set of viewing angles
331-335 range of viewing angles
340, 350 range of viewing angles relative to scene
400 coordinate system associated with scene
410-414 path through scene
420 viewing direction
430 field of view
440 finest angle of granularity
500 computer-readable medium
510 non-transitory data
1000 exemplary data processing system
1002 processor
1004 memory element
1006 system bus
1008 local memory
1010 bulk storage device
1012 input device
1014 output device
1016 network adapter
1018 application

### DESCRIPTION OF EMBODIMENTS

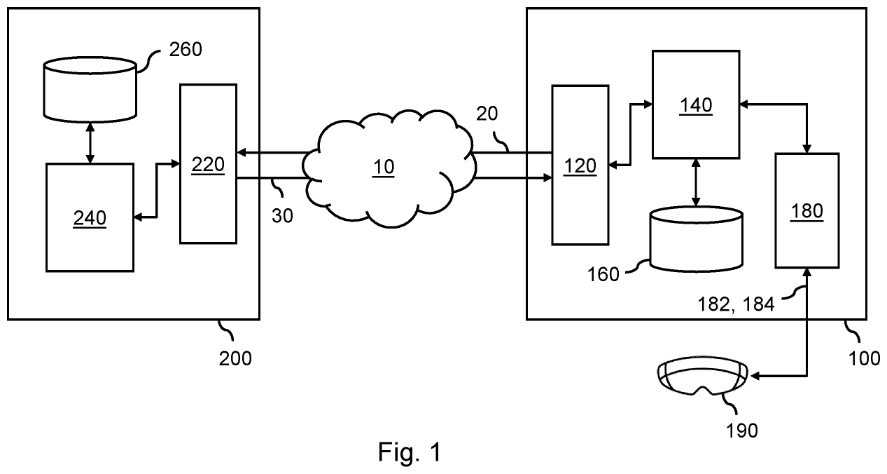

FIG. 1 shows a client device 100 and a server system 200 which may communicate with each other via a network 10. The server system 200 may be configured to stream a video-based representation of an object as one or more video streams to the client device 100. The client device 100 may be configured to render a scene and, as part of the rendering, place the video-based representation of the object at an object position within the scene. More specifically, FIG. 1 shows an example of the client device 100, which client device 100 may comprise a network interface 120 to the network 10, a processor subsystem 140, a data storage 160 and a display interface 180, with each of said components being described in more detail elsewhere in this specification. The client device 100 may be configured to render a scene from a viewing position within the scene to obtain a rendered view of the scene. The rendering of the scene may comprises placing the video-based representation of the object at an object position within the scene. A relative position between the viewing position and the object position may be determined, for example by the client device 100, which may then signal the relative position, or parameters derived therefrom, in the form of metadata 20 to the server system 200. The server system 200 may comprise a network interface 220 to the network 10, a processor subsystem 240 and a data storage 260, and may be configured to generate the one or more video streams to show the object from a limited set of viewing angles, wherein the limited set of viewing angles may be selected based on the relative position, and to stream said video stream(s) 30 via the network 10 to the client device 100. In a specific example, the video stream(s) may be encoded using an adaptive streaming technique, such as, but not limited to, MPEG DASH (Dynamic Adaptive Streaming over HTTP). The client device 100 may then select a viewing angle from the limited set of viewing angles and place the video-based representation of the object at said selected viewing angle in the scene. The rendered view of the scene may in some embodiments be displayed, e.g., by outputting display data 182 via the display interface 180 to a head-mounted display 190. In some embodiments, the client device 100 may also receive sensor data 184, for example via the display interface 184 from one or more sensors integrated into the head-mounted display 190, for example to allow a user to select a viewport of the scene which is rendered by the client device 100, for example by simply turning his/her head.

The following may also refer to the client device simply as ‘client’, to the server system simply as ‘server’, and in some examples, reference may be made to panoramic videos which may be available for streaming from the server system 200 and which videos may be available for a number of viewpoints within the scene. In some examples, the panoramic videos may be omnidirectional videos which may in the following also be referred to as pre-rendered viewing areas (PRVAs).

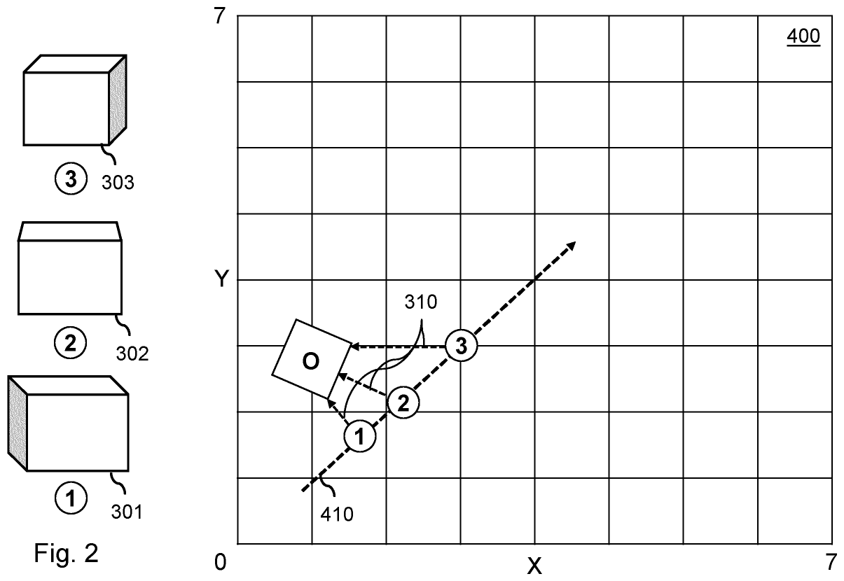

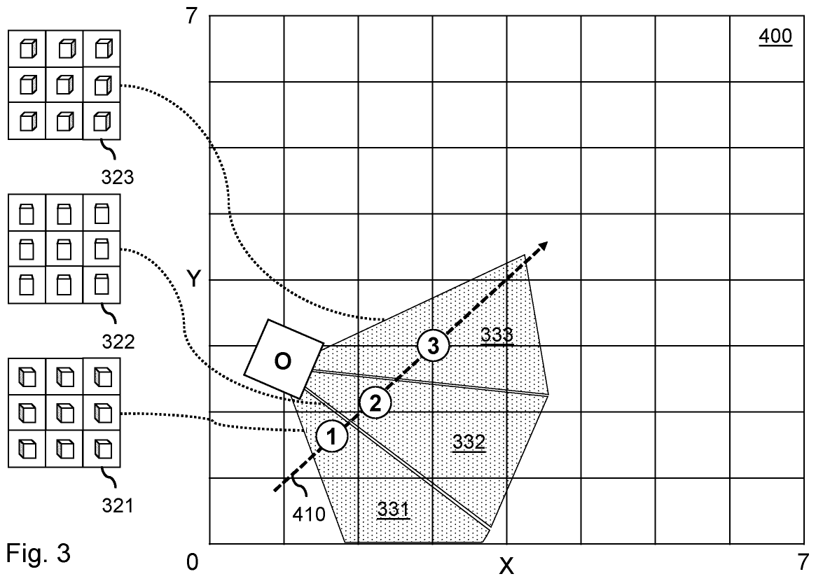

FIG. 2 show a top-down view of a scene 400, which scene may here and in FIGS. 3-9 be schematically shown as a 2D grid which may show a 3D scene from above (‘top-down’). The 2D grid may be addressable using a coordinate system. In the example of FIGS. 2-9, the 2D grid's coordinates may run from 0 to 7 on the X-axis and from 0 to 7 on the Y-axis. Note that the Z-axis is not shown for ease of illustration. The grid coordinates may for example correspond to actual geolocations, e.g., when the scene corresponds to a real-life scene which may be recorded at different coordinates but may alternatively represent coordinates which have no direct physical analogy, e.g., when the scene is a virtual scene defined by computer-graphics. It can be seen in FIG. 2 that there may be an object in the scene, labeled ‘O’ in FIG. 2 and elsewhere, which object may, for ease of illustration, be a cube. The object O may be visible from a number of viewpoints 1-3 in the scene, which viewpoints may denote different positions at which the scene 400 may be rendered. For example, the viewpoints 1-3 may denote different positions of a virtual camera or a viewport over time. The viewpoints 1-3 may be located along a path 410 through the scene 400, while their numbering may indicate a sequential movement through the scene 400, e.g., from viewpoint 1 to 2 to 3.

It can be seen that the object's appearance may change between the viewpoints 1-3. Namely, as can be seen on the left-hand side of FIG. 2, due to the movement through the scene, the perspective but also apparent size of the object O may change when viewed from the respective viewpoints 1-3. In particular, in the view 301 of the object O obtained at viewpoint 1, the object O may appear relatively large and may be visible diagonally from the left-hand side, while in the view 302 obtained at viewpoint 2, the object O may appear smaller and may be visible more frontally, while in the view 303 obtained at viewpoint 3, the object O may appear yet again smaller and may be visible diagonally from the right-hand size. This difference in perspective may be due to the direction and distance at which the object O is viewed changing between the viewpoints 1-3. The direction and distance are in FIG. 2 schematically indicated by arrows 310 which denote the relative position between the respective viewpoint 1-3 and the object O. This relative position may for example be defined as a vector pointing from the viewpoint 1-3 to the object O, or vice versa, and may thus have a distance and a direction. While the distance may determine the apparent size of the object O in the respective views 301-303, the direction may determine the angle at which the object is viewed, which angle may here and elsewhere also be referred to as ‘viewing angle’.

FIG. 3 again shows the scene 400, the viewpoints 1-3 along the path 410 and the object O, but additionally illustrates the following: the server system of FIG. 1 may stream a video-based representation of the object O as one or more video streams to the client device of FIG. 1. The object O may be available to the streaming server in a 3D format, for example by the object O being originally defined as computer graphics or as a volumetric video, or may be synthesizable to be shown at different viewing angles, e.g., from different video recordings which may be available of the object O. Such synthesis may elsewhere also be referred as ‘view synthesis’ or ‘viewpoint synthesis’, and may be known per se. For example, the paper GauGAN: semantic image synthesis with spatially adaptive normalization, July 2019, ACM SIGGRAPH 2019 Real-Time Live!, describes an example of such view synthesis. As the view of the object O changes between viewpoints 1-3, the server system may need to update the view of the object O in the video stream(s), e.g., by showing the object O from a different viewing angle. However, in practice, there may be many intermediate viewpoints along the path 410, e.g., before viewpoint 1, in between viewpoints 1-2, in between viewpoints 2-3, etc. As elucidated elsewhere, it may be disadvantageous to have to continuously update the video stream(s) to show the object O at the appropriate angle, for example as it may be difficult to synchronize such updates to the video stream(s) at the server system to a change in viewpoint at the client device, e.g., due to the latency between the server system and the client device.

To avoid such and other disadvantages, the server system may generate the video stream(s) to concurrently show the object O from a limited set of different viewing angles, thereby effectively showing the object O from the perspective of several viewpoints (instead of one viewpoint) on the path 410. The viewing angles may be determined based on a relative position between a viewing position of the client device and the position of the object O in the scene 400. The viewing position may be a position at which the client device renders the scene 400, e.g., corresponding to a position of a virtual camera or viewport, and which may for example move along the path 410 through the viewpoints 1-3. As such, the video stream(s) may concurrently cover a range of viewing angles, and in particular a number (but limited number) of viewing angles, instead of showing object O only at a single viewing angle. Such limited set of viewing angles may in the following also be referred to as a ‘range’ of viewing angles, with the understanding that the range may be limited with respect to a larger range of all possible viewing angles at which the object can be shown, and with the understanding that the video stream(s) may typically show the object from a limited number of (discrete) viewing angles within the range and not at every viewing angle. Such a range of viewing angles is in FIG. 3 and elsewhere illustrated as an arc-shaped area 331, 332, 333 which may indicate positions in the scene 400 at which the object O may be visible at a viewing angle which falls within such a range of viewing angles.

For example, as shown on the left-hand side of FIG. 3, the server system may at different times generate different spatial mosaics 321-323 of the object O for different ranges of viewing angles, which spatial mosaics may also be known as ‘quilts’. Here, each mosaic may be a spatially multiplexed view of the object at different viewing angles, in that each view in the 3×3 mosaic may show the object from a different viewing angle. Such a mosaic may elsewhere also be referred to as a ‘grid’ or a ‘quilt’. The views in such a mosaic, which may each represent a video-based representation of the object at a different viewing angle, may elsewhere also be referred to as ‘elements’ or ‘modules’ or ‘mosaic tiles’ or ‘quilt tiles’ or ‘viewing angle tiles’ (referring to each element/module/tile of the mosaic showing the object from a different viewing angle) or the like. The following may for sake of explanation refer to ‘mosaic tiles’. It will be appreciated that if the video-based representations of the object are provided in another manner than in a spatial mosaic, e.g., in a temporally multiplexed manner, the individual video-based representations of the object may be referred to differently, e.g., as ‘views’ or ‘elements’ or ‘frames’ or ‘viewing angle elements’ or ‘viewing angle frames’, etc. As will also be elucidated elsewhere, the manner of providing the video-based representations of the object, e.g., in spatial mosaic (including which type of spatial mosaic) in a temporally multiplexed manner, etc., may elsewhere be referred to as an ‘arrangement’, being for example a spatial or a temporal arrangement.

With continued reference to FIG. 3: it will be appreciated that the differences in viewing angle between each view of the mosaic may be small, e.g., 1° or 2°, and that FIG. 3 for sake of illustration omits showing such minute changes in viewing angle in the mosaics 321-323. It will be appreciated, however, that in practice such changes in viewing angle may be visible, and in fact, may be clearly visible, e.g., when the changes in viewing angle are relatively large and/or when the object is nearby the viewing position and/or when the object is of cognitive interest to a viewer, etc. Each entire mosaic 321-323 may at different times be streamed to the client device, e.g., as a single encoded version of a spatial mosaic of different videos, or as a temporally multiplexed version of such different videos, or using multi-view coding (MVC), etc. For example, if the latency between the client device and the server system is relatively high and the path 410 may be predicted with some expectancy of success, the server system may start streaming a respective mosaic once the viewing position moves within the range of viewing angles 331-333. In other examples, the server system may receive or determine the viewing position of the client device and may generate a mosaic showing the object from a current viewing angle and from a number of viewing angles to the right and to the left to allow movement of the viewing position to either side of the object based on the range of viewing angles included in the video stream(s).

As also elucidated elsewhere in this specification, the range of viewing angles may be determined in various ways based on the relative position. For example, the direction from a viewing position to the object, or vice versa, may be used to determine the range of viewing angles within the larger range of possible angles from which the object can be rendered. The larger range may for example cover [0°, 360°], while the smaller range may elsewhere also be referred to as a sub-range or an ‘interval’. The direction may also be referred to as ‘relative direction’ and may indicate a current viewing angle (and may not be confused with ‘viewing direction’ as elucidated elsewhere, which may indicate a direction of a virtual camera or viewport or the like in the scene). For example, the interval may be chosen to be centered with respect to a current or predicted relative direction (i.e., a current or predicted viewing angle), or may be offset so that the current or predicted viewing angle forms the minimum or maximum of the interval. In some examples, the width of the interval may be selected based on a distance from the viewing position to the object position, or vice versa, which distance may also be referred to as ‘relative distance’. For example, the width of the interval, the number of viewing angles within the interval, and/or the spacing of the viewing angles within the interval, may be selected based on the relative distance to the object.

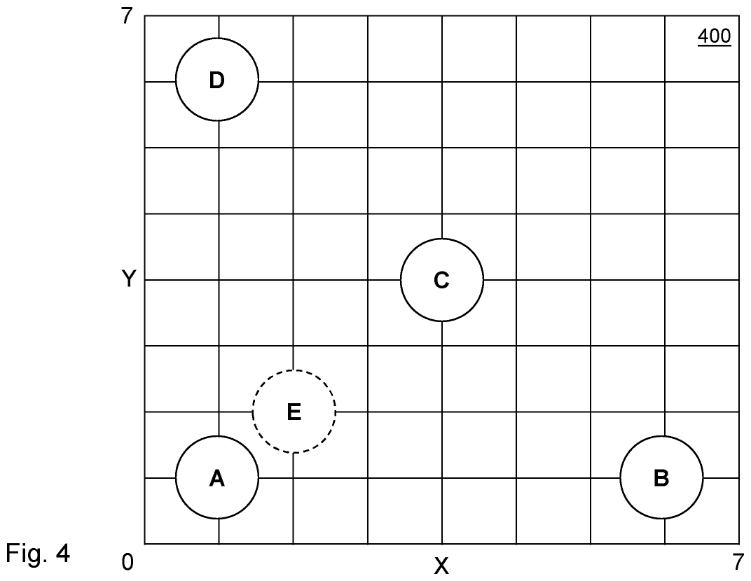

FIG. 4 illustrates an example of an application in which the aforementioned video stream(s) may be used to show an object from a limited set of viewing angles. This application example may be explained as follows. A plurality of panoramic or omnidirectional videos of a scene may be available for streaming. For example, these panoramic videos may have been previously acquired, e.g., by a plurality of cameras, or may have been previously synthetically generated, or may in some examples be generated in real-time. An example of the latter is a soccer match in a soccer stadium being recorded by a plurality of panoramic cameras corresponding to different viewpoints within the stadium, each viewpoint being selectable for streaming. In case a panoramic video is originally acquired at or generated for a viewpoint, e.g., by an omnidirectional camera or by offline rendering, such a panoramic video may also be referred to as a pre-rendered view-area (PRVA), referring to the video content being available in a pre-rendered manner to a streaming client, rather than the streaming client having to synthetically generate the video content. In the example of FIG. 4, such PRVAs may be available at viewpoints A-D. Accordingly, if the viewing position of the client device is located at or near viewpoint A, the server system may stream a PRVA in form of a panoramic video for the location A to the client device, which PRVA may elsewhere also be referred to as PRVA A. Likewise, if the viewing position of the client device is located at or near viewpoint B, the server system may stream a PRVA in form of a panoramic video for the location B to the client device, which PRVA may elsewhere also be referred to as PRVA B, etc. In some examples, if the viewing position of the client device is located at an intermediate position between the viewing positions at which PRVAs are available, i.e., between the viewpoints of the scene shown by the PRVAs, the server system may synthesize a PRVA, for example based on the video data of surrounding PRVAs. In the example of FIG. 4, at viewpoint E, a panoramic video may be synthesized based on for example the video data of PRVA A, and/or based on the video data of a combination of PRVA's, e.g., PRVA A and C, or PRVAs A-D. As elucidated elsewhere, such viewpoint synthesis is known per se and also described in the co-pending application PCT/EP2021/076598 of the applicant, which also describes efficiently synthesizing viewpoints by sharing video data between viewpoints, which viewpoint synthesis techniques are hereby incorporated by reference.

By way of example, the following examples assume the panoramic videos to be omnidirectional videos, e.g., 360° videos. However, this is not a limitation, in that the measures described with these and other embodiments equally apply to other types of panoramic videos, e.g., to 180° videos or the like. In this respect, it is noted that the panoramic videos may be monoscopic videos, but also stereoscopic videos or volumetric videos, e.g., represented by point clouds or meshes or sampled light fields.

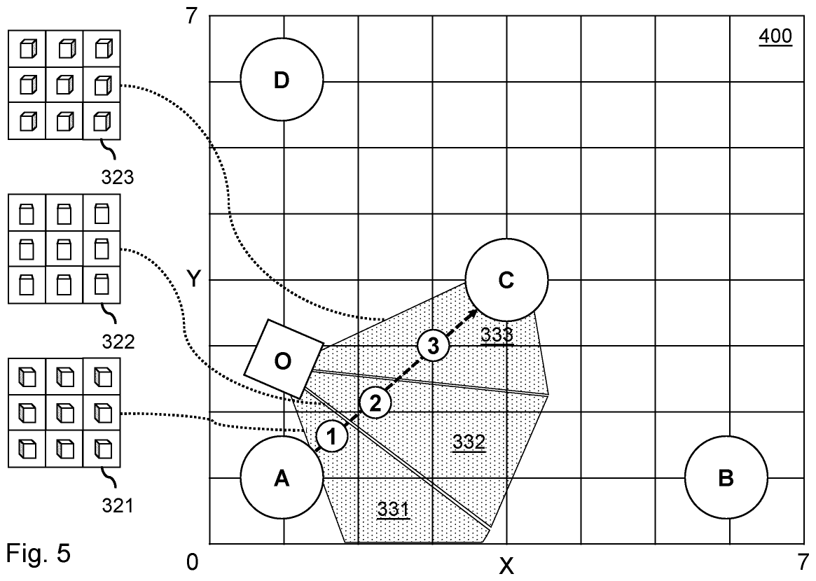

FIG. 5 is similar to FIG. 3 but shows the video stream(s) generated by the server system being used to render the object O on a path between pre-rendered viewing areas A and C in the aforementioned scene 400. Effectively, FIG. 5 may show the generation of mosaics 321-323 as described with reference to FIGS. 2 and 3 being used in the application example of FIG. 4 in which PRVAs are available for viewpoints A-D within the scene 400. In this and other examples, the video stream(s) may be generated by the server system based on the client device indicating to the server system which PRVA stream(s) the client device wishes to receive and by the client device providing additional information, e.g., as metadata, to the server system so the server system is able to generate the object O at a range of viewing angles along the path between the PRVAs, e.g., at the viewing positions 1-3 between PRVAs A and C. In this and following examples, the object may be shown at the range of viewing angles by the server system synthesizing additional views/angles of object O from the views of the object O shown already in PRVAs A (and PRVA C, possibly also PRVA B and D).

This may for example involve the following steps:
1. The client may receive information from the server, such as a media presentation description (MPD) listing of available video streams for the scene and data defining the scene in terms of geometry (e.g., which PRVA and which object is located where in the scene).
2. On movement between PRVA A and C to viewing position 1:
a. The client may retrieve PRVA A by streaming.
b. The client may set up a connection with the server, such as a RTP (Real-time Transport Protocol) connection.
c. The client may transmit its current viewing position and PTS (Presentation Time Stamp, as also explained below) to the server.
d. The server may synthesize missing viewing angles of object O.
e. The client may receive a video-based representation of object O at a limited number of viewing angles, e.g., in form of the mosaic 321.
f. The client may use the video-based representation of object O at a number of viewing angles to overlay the video data of object O over PRVA A.
3. On movement between PRVA A and C from viewing position 1 to 2:
a. The client may use the video data of PRVA A.
b. The client may use the mosaic 321 with the correct viewing angle of the object O being selected depending on the exact viewing position.
c. When the client moves outside of the area of validity (AOV) indicated by the area/range of viewing angles 331, the client may retrieve the mosaic 322 by streaming and use the mosaic 322 to render the correct viewing angle of the object O.
4. On movement between PRVA A and C from viewing position 2 to 3:
a. Client may retrieve PRVA C by streaming.
b. Client may use the mosaic 322, with the correct viewing angle of the object O being selected depending on the exact viewing position.
c. When the client moves outside of the AOV indicated by the area/range of viewing angles 332, the client may retrieve the mosaic 323 by streaming and use the mosaic 323 to render the correct viewing angle of the object O.
5. On movement between PRVA A and C from viewing position 3 to C:
a. Client may use the video data of PRVA C.
b. Client may use the mosaic 323, with the correct viewing angle of the object O being selected depending on the viewing position.

The image or video that may be synthesized for the object O and the number of viewing angles in a mosaic (or in general, in the video stream(s) containing the video-based presentation of the object O) may depend a number of factors, for example on parameters which may be transmitted by the client device to the server system. Such parameters may include, but not need to be limited to one or more of:
Presentation Time Stamp (PTS): This parameter may be derived from the client from a current playout time of a PRVA, and may be used by the server to determine what temporal part of the video data of a PRVA (or of several PRVAs) is to be used to synthesize the object.
Viewing position in the scene. The viewing position, e.g., as a 2D or 3D position defined in space, may be used by the server to calculate the distance and the direction to/from the object, e.g., in form of a vector defining a distance and a direction.
Viewing direction. This parameter may be used to indicate the viewing direction of the client, which may, but does not need to, be in the direction of the object. The viewing direction may for example define the direction of the virtual camera used by the client to render the scene. Together with data defining the viewport and the viewing position, the viewing direction may determine which objects are in view.
Field of view: This parameter may define the maximum (angular) area at which the client may image the 3D space of the scene, and may be an example of ‘data defining the viewport’ as referenced above. Together with the viewing direction and viewing position, this parameter may determine which objects are in view.
Motion to Photon (MTP) latency: This parameter may define the time it takes for the client to receive the mosaic after sending a request (explicit or implicit).

The use of these parameters, for example by the server system, may also be explained elsewhere in this specification.

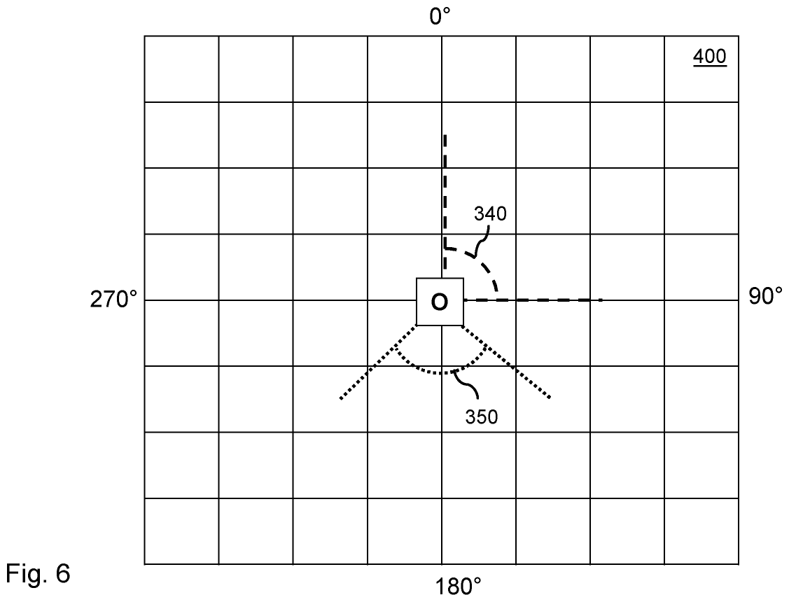

FIG. 6 shows the alignment between a coordinate system associated with the scene 400 and the range of viewing angles at which the object is shown. This figure may be further explained as follows: a video stream(s) provided by the server system may show the object at a limited set of angles. For a client device, to be able to place the video-based representation of the object in the scene before or when rendering the scene, the client device may make use of one or more parameters:
Object position. The object position, for example defined as X,Y,Z values, may define where in the scene the object should be placed, for example with the center of the object.
Orientation. The orientation may define how the viewing angles of the object in the video stream(s) relate to the coordinate system of the scene, e.g., to the absolute north of the scene. The orientation may for example be defined in degrees between [0°, 360°]. An example is given in FIG. 6, where the orientation for two different mosaics is shown relative to the orientation of the scene 400 (as defined in degrees between [0°, 360°]), namely one in which the object's viewing angles are viewable from between 0° and 90° (defined by the minimum of the range 340 pointing north/0° and the maximum of the range pointing east/90° and the range 340 being 90° wide) and one in which the object's viewing angles are viewable from between 135° and 225° (defined by the minimum of the range 350 pointing south-east/135° and the maximum of the range pointing south-west/225° and the range 350 being again 90° wide).
Range: This parameter may define the range of viewing angles in the video stream(s) relatively to the center (position) of the object, as also shown in FIG. 6 and elsewhere also referred to as a ‘width’ of the range or width of an ‘interval’. The range may for example be defined in degrees between [0°, 360°].
Center Angle: This parameter may identify a reference view in the video stream(s). For example, for a spatial mosaic, the center angle may identify the mosaic tile which may show the object at the viewing angle at a time of the request by the client. The center angle parameter may be used together with the viewing position to select a mosaic tile from the spatial mosaic for a current viewing position, which may have changed with respect to the viewing position at a time of the request.
Scale: This parameter may define how the object shown in the video stream(s) scales relatively to other content of the scene such as PRVA's. For example, if the object in the PRVA is shown at a width of 100 pixels and the object is shown in the video streams at a width of 200 pixels, the scale may be 2.0.

The number of viewing angles at which the object is shown in the video stream(s) and the width of the range may together define the granularity of the viewing angles at which the object is shown in the video stream(s). In general, the closer the viewing position is to the object, the higher the granularity may be, as also discussed elsewhere in this specification.

As described elsewhere in this specification, the range of viewing angles at which the object is shown in the video stream(s) may be selected based on various parameters, including but not limited to the latency between server system and client device. For example, the so-called motion-to-photon (MTP) latency experienced at the client device may be used to determine the number of viewing angles sent by the server system. The MTP may be an aggregate of individual latencies in the video delivery pipeline and may for example include: defining the viewing position in 3D space, indicating the viewing position to the server system, synthesizing video-based representations of the object at the server system, arranging the video-based representations with respect to each other (e.g., in a spatial mosaic or in a temporally multiplexed manner), encoding the video-based representations of the object, packaging, transmitting, unpacking, decoding and rendering the video-based representations of the object. To be able to calculate the MTP latency, one may identify when a request is sent by the client device and when the response (a video-based representation which shows the object at a particular viewing angle) is displayed by the client device. For that purpose, the server system may signal the client device which video frames represent a response to which request of the client device. The MTP latency may then be determined as ‘Time of display-Time of request’. The server system may for example indicate which video frames belong to which request by indicating the ‘RequestID’ or ‘RequestTime’ as metadata, where the former may be any number that increases with a predictable increment and the latter may be a time measurement, for example defined in milliseconds. To be able to know to which video frame the metadata correlates, the server system may for example send either a ‘FrameNumber’ or Presentation Time Stamp ‘PTS’ to the client device, e.g., using a protocol described elsewhere in this specification.

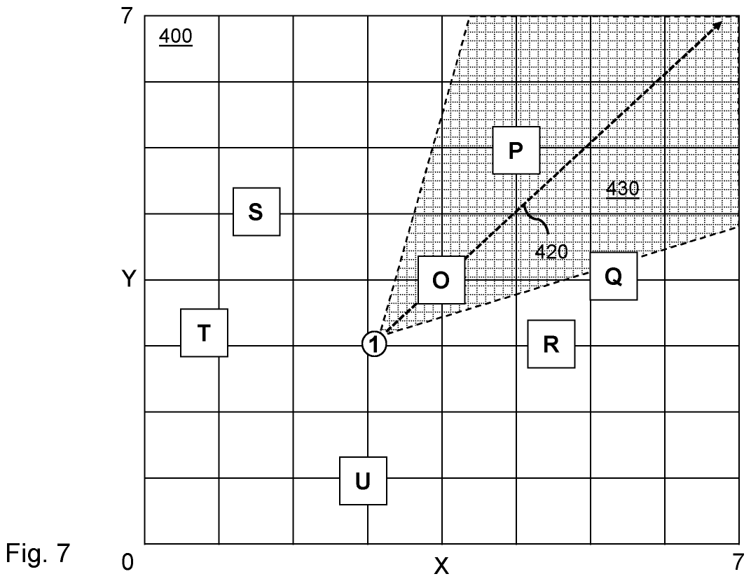

FIG. 7 shows the client device at viewing position 1 having a field of view 430 within the scene 400, with the visibility of objects O-U being dependent on whether they are within the field of view. This figure may be further explained as follows: the server system may in some examples determine which objects to stream to the client device based on the viewing position used by the client, as well as the viewing direction 420 and the field of view 430 as indicated in FIG. 7. After determining which objects are in view, this being in the example of FIG. 7 objects O and P and object Q partially, the server system may synthesize the video-based representation of the objects O and P (and possibly Q) at different viewing angles. For example, the server system may take into account the current viewing position and viewing direction and possible future viewing positions and viewing directions. It is noted that such prediction is known per se. Having obtained such predictions, the server system may synthesize the objects O, P (and possibly Q) at the current and possible future viewing angles and create the video stream(s).

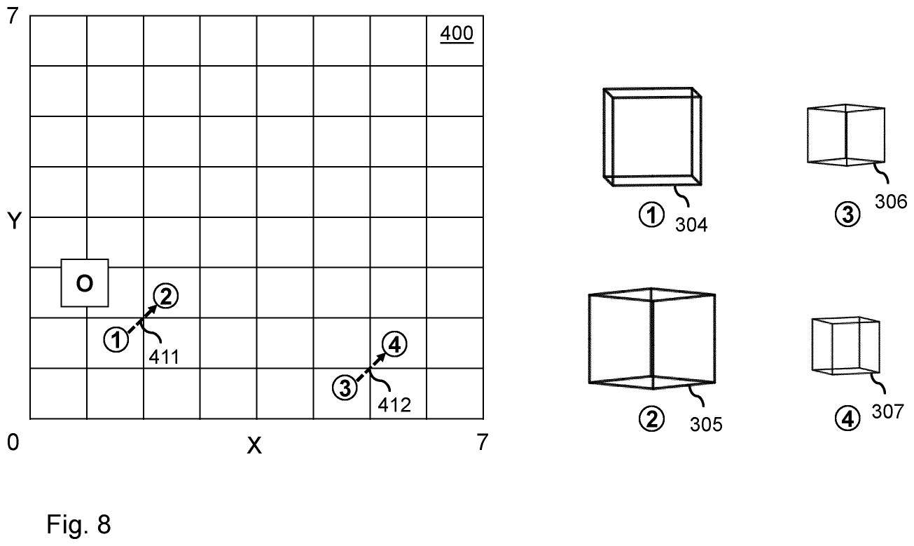

FIG. 8 illustrates the effect of the distance of the viewing position to the object position for a same size of movement within the scene. This figure may serve to explain how the number of viewing angles may be determined, e.g., in terms of number (granularity within the range) and distribution. Namely, the distance from the viewing position, being in this example viewing positions 1-4, to the object O may determine how much an object changes in appearance when moving over a same distance through the scene. This is illustrated in FIG. 8, where it is illustrated that the views 304, 305 of the object O change significantly when moving 411 from viewpoint 1 to viewpoint 2, while the views 306, 307 of the object O change less so when moving 412 from viewpoint 3 to viewpoint 4. In addition, as a logical consequence of the larger relative distance, the object may appear smaller at viewpoints 3 and 4 than at viewpoints 1 and 2, which may allow the video-based representation of the object to be smaller as well, e.g., in terms of pixels, voxels or the like. In general, the closer the viewing position may be to the object, the larger the set of viewing angles provided by the video stream(s) may be, both in terms of width of the interval covered by the set of viewing angles and the granularity (number) of viewing angles within the interval. Similarly, the MTP latency, or other measure of latency between the client device and the server system, may also determine the set of viewing angles, in that a larger latency may require a wider interval so as to compensate for the larger latency.

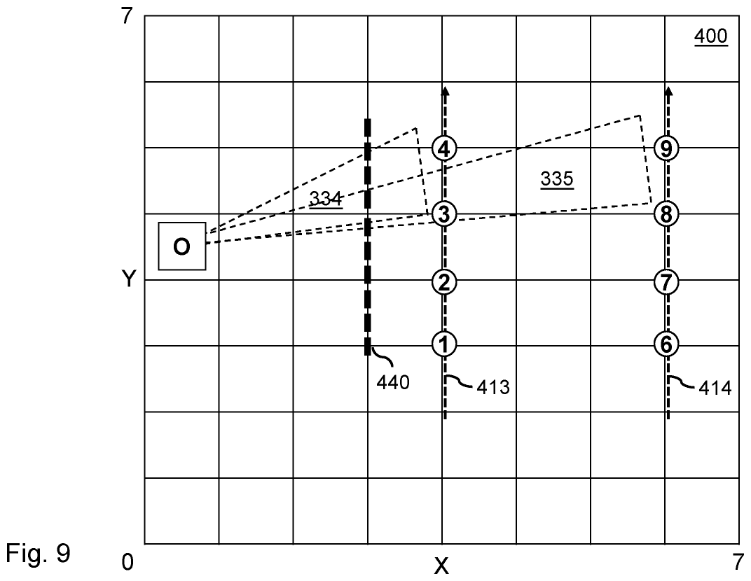

FIG. 9 illustrates the spacing of viewing angles for the limited set of viewing angles at which the object is shown in the one or more video streams. This figure may be explained as follows. Two paths 413, 414 are shown through the scene 400, with a first path 413 passing through viewpoints 1-4 and a second path 414 passing through viewpoints 6-9. This example may illustrate that, when moving a distance unit through the scene 400 (e.g., a distance of ‘1’ in the coordinate system of the scene 400), a given spacing of viewing angles may result in more or fewer viewing angles of the object being included in the spatial mosaic during the movement depending on the distance to the object O. For example, when assuming a particular spacing of viewing angles, which may be represented in FIG. 9 by a grid 440 which may represent a finest angle of granularity at that distance to the object, the viewer may perceive the object O at fewer viewing angles when moving a distance unit along the second path 414 than along the first part 413. Namely, as the first path 413 is closer to the object O than the second path 414, when moving between position 3 and 4 on the path 413, this would result in the object being shown at around 4 successive viewing angles, whereas moving between position 8 and 9 on the path 414 would result in the object to be shown at around 2 successive viewing angles. The spacing of viewing angles may thus be determined based on the expected distance to the object O and the visual requirements of how many viewing angles should be shown when moving one distance unit in the scene. In another example, MTP may be additionally taken into account. When for example assuming that the viewing position may move 1 distance unit per second and the MTP delay is 1 second, the video stream(s) may need to show the object at (3×4=) 12 viewing angles on the first path 413 and (3×2=) 6 on the second path 414, as the viewing position may move faster through the scene 400 than the server system is capable of creating and delivering video streams to the client device via the network. The calculation of the number of viewing angles may be explained as follows. If for example the current viewing position is at position 3 on path 413, the next viewing position 4 or the previous viewing position 2 may both be reached in one second. If the MTP delay is 1 second, the spatial mosaic may preferably show the viewing angles of the object O for positions 2-4, which when showing 4 viewing angles for each distance until, equals the aforementioned (3×4=) 12 viewing angles.

Without reference to a particular figure, it is noted that the size and/or spatial resolution of the video-based representation of the object in the video stream(s) may be selected in various ways, for example based on the size at which the client device places the video-based representation in the scene, which in turn may be dependent on the distance to the object, and in general, the relative position between the viewing position and the object position. The spatial resolution may thus be selected to avoid transmitting video data which would anyhow be lost at the client device, e.g., by the client device having to scale down the video-based representation. As such, in some examples, the server system may determine the (approximate) size at which the object is to be placed in the scene by the client device and select the spatial resolution of the representation of the object in the video stream(s) accordingly.

### Communication Between Client and Server

In general, the client device (‘client’) and the server system (‘server’) may communicate in various ways. For example, bidirectional communication between client and server may take place via WebSocket or a message queue, while so-called downstream communication between server and client may take place via out-of-bound metadata, e.g., in the form of a file, e.g., in XML or CSV or TXT format, or as a meta-data track in, e.g., an MPEG Transport Stream or SEI Messages in an H264 video stream. The following defines examples of a protocol for use-cases (which may be defined as examples or embodiments) described earlier in this specification.

### Client to Server

The client may communicate with the server by providing data such as its viewing position, its current PTS and by providing other data the server may need to generate the video stream(s) of the object. By way of example, the following table defines parameters that may be signalled to the server. Here, the term ‘mandatory’ may refer to the parameter being mandatory in a protocol according to the specific example, but does not denote that the parameter in general is mandatory. In other words, in variations of such messages, a parameter may be optional. Also a preferred Type is given, which in variations may be a different Type.

Init Request

| Field | Type | Mandatory | Comments |
|---|---|---|---|
| FieldOfView | Text | Yes | Frustrum |

Init Response

| Field | Type | Mandatory | Comments |
|---|---|---|---|
| SessionID | Integer | Yes | |
| Msg | Text | Yes | E.g., OK or NOK |

At a position change

| Field | Type | Mandatory | Comments |
|---|---|---|---|
| SessionID | Integer | Yes | |
| RequestNumber | Integer | Yes | May be used to |
| | | | correlate the |
| | | | synthesized image |
| | | | with the request. May |
| | | | be used for MTP |
| | | | latency calculations. |
| PTS | Integer | Yes | |
| Position | Text | Yes | X, Y, Z |
| ViewingDirection | Decimal | Yes | Degrees relative to |
| | | | the north in the |
| | | | scene |
| MTP | Integer | Yes | E.g., average MTP in |
| | | | milliseconds |

### Server to Client

The server may be responsible for signalling information to the client, for example to enable the client to calculate the MTP delay and to enable the client to determine the position of an object within the 3D space of the scene.

Communicating information for MTP delay

| Field | Type | Mandatory | Comments |
|---|---|---|---|
| SessionID | Integer | Yes | |
| RequestNumber | Integer | Yes | |
| FrameNumber | Integer | No | May be mandatory if |
| | | | PTS is omitted |
| PTS | Integer | No | May be mandatory if |
| | | | FrameNumber is |
| | | | omitted |

Communicating position of objects in space

| Field | Type | Mandatory | Comments |
|---|---|---|---|
| SessionID | Integer | Yes | |
| RequestNumber | Integer | Yes | |
| StreamID | Text | Yes | Identifier of the |
| | | | stream containing |
| | | | the object. May be |
| | | | an URL or StreamID |
| | | | depending on how |
| | | | the information is |
| | | | streamed. |
| Position | Text | Yes | X, Y, Z |
| Orientation | Integer | Yes | May define the |
| | | | orientation of the |
| | | | object in the video |
| | | | stream(s) relatively |
| | | | to the north within |
| | | | the scene. |
| NumberOfRows | Integer | Yes | May be needed for |
| | | | the client to be able |
| | | | to split up the frame |
| | | | in the correct |
| | | | number of mosaic |
| | | | tiles. |
| MosaicTilesPerRow | Integer | Yes | May be needed for |
| | | | the client to be able |
| | | | to split up the frame |
| | | | in the correct |
| | | | number of mosaic |
| | | | tiles. |
| CenterAngle | Integer | No | |
| Range | Integer | Yes | May define the range |
| | | | of angles in degrees. |
| Scale | Decimal | Yes | |

The above message may be sent at least once and/or when the video stream(s) are changed, for example when a new streaming source is used or the contents of the current video stream(s) changes (e.g., when the video stream(s) show the object at a different range of viewing angles, or when the spatial resolution changes, or when the size of the object changes, or when the centre angle changes).

Transport of Video Stream(s) from Server to Client

The transport of video stream(s) from the server to the client may for example be based on streaming using protocols such as RTSP, MPEG TS, etc., or segment-based streaming (‘segmented streaming’) using protocols such as DASH and HLS. Non-segmented streaming may be advantageous as its MTP latency may be lower, while segmented streaming may have a higher MTP latency but does provide the ability for caching and may thereby eventually save processing power and bandwidth. In general, the video(s) may be encoded using any known and suitable encoding technique and may be transmitted in any suitable container to the client.

### Segmented Streaming

Because the segments in segmented streaming may be created at runtime by the server system, the MPD, which may in some examples be provided to the client device, may not define the media source but instead provide a template for requesting the video content. This template may for example define a endpoint at which the video content may be retrieved, for example as follows:
http://endpoint/FOV/PTS/Position/ViewingDirection/SegmentNumber

Segmented streaming may enable re-use by other clients, and as such, the server system may not require a client to provide parameters such as SessionID and RequestNumber. By navigating to the above endpoint without ‘SegmentNumber’, the client may be able download the first segment for the specified PTS. In some examples, segments may have a standard size, for example 2 seconds. To request the next segment, the client may add an integer 1 (counting from 0) to SegmentNumber. For example, to request PTS+6 seconds, the client may request SegmentNumber 3.

### Non-Segmented Streaming

In some examples, the client may receive a separate video stream for every object within the scene that is visible within the client's viewport, while in other examples, a video stream may cover two or more objects. In the former case, to know what video streams to setup, the server may signal the ‘StreamID’ for the objects which are visible to the client so that the client may setup the streaming connections for the video stream(s) accordingly. See also the table titled ‘Communicating position of objects in space’ elsewhere in this specification. For every ‘StreamID’, the client may:
1. Indicate values as specified in the messages under the heading ‘Client to server’, e.g., via WebSocket
2. Setup a connection, e.g., using RTP, using the StreamID
3. Receive the video stream via the connection

For every change in viewing position, the client may receive a new array containing objects that are in view.

The following discusses further examples and embodiments.

### Alternative Containers for Viewing Angles

Receiving a video stream, or even more video streams per object, may require the client to instantiate multiple decoders, which may be (computationally) disadvantageous or not possible, e.g., if hardware decoders are used which are limited in number. The number of required decoders may however be decreased, e.g.:
Depending on the number of objects and the viewing angles at which the objects are shown, the objects may be combined within one video stream, for example within one video frame. For the client to know which part of the video frame belongs to which object, additional signaling may be introduced. For example, a rectangle may be defined for each object, and the rectangle may be signaled from the server to the client in a two dimensional array. For example, the array may be defined as [“obj”: “x,y,h,w”] where ‘obj’ is the ID of the object, x and y are the position of the top left corner of the rectangle containing the object in the video frame and h and w are the height and width of the rectangle.
Containers such as MP4 and MPEG-TS may contain multiple video streams. Per stream, signaling may be used to indicate to the client which video stream belongs to which object. This signaling may involve transmitting a multidimensional array, e.g., [[“obj”: 0]] where ‘obj’ is the ID of the video stream and the integer indicating the position of the video stream within the container, with the first video stream starting at 0 (as indicated in the example above).
Another option may be to temporally interweave the video frames, which may also be known as ‘temporal multiplexing’ and is elsewhere also described as a technique for showing different viewing angles of the object. Accordingly, different video frames may contain image information for different objects. For the client to know which video frame belongs to which object, additional signaling may be introduced. As long as the order of objects within the video stream remains the same, it may be sufficient to indicate the first frame number in which a particular object will be present, for example starting from a specific PTS. The client may determine for the rest of the video frames in which video frame which object is present, until an update of this message is received. The message may be: [“PTS”: 0, [“obj”: 0]]] where the PTS field may indicate the PTS from when these signals will be valid and ‘obj’ may be the ID of the object and the following integer the first frame in which that object is present.

### Lower Spatial Resolution at Movement

A spatially multiplexed video frame showing the object from a range of viewing angles may require a relatively high spatial resolution. During movement of the viewing position, it may be difficult for a user to focus well on the objects contained in the scene. Spatially high-resolution content may therefore be not needed when the viewing position moves, in particular when the movement is relatively fast. This means that there may not be a need to transmit such high-resolution frames, nor for the server to generate such high-resolution frames, e.g., using synthesis techniques. The server may therefore decide to reduce the spatial resolution during movement. If decided, the server may provide an update of the information given in the table titled ‘Communicating position of objects in space’ described previously in this specification.

### Signalling Maximum Viewing Angles and Spatial Resolution

The MTP latency, also referred to as MTP delay, may depend at least in part on the speed at which client may decode the received video stream(s). To reduce the MTP delay, the client may indicate to the server that the spatial resolution of a video frame should be limited, for example by limiting the spatial resolution of a mosaic tile and/or by limiting the number of mosaic tiles, to be able to decode the video frame representing the spatial mosaic in time. This may be done by the following signalling being provided from client to server:

| Field | Type | Mandatory | Comments |
|---|---|---|---|
| SessionID | Integer | Yes | |
| ObjectID | Integer | Yes | |
| MaxMosaicTileWidth | Integer | Yes | |
| MaxMosaicTileHeight | Integer | Yes | |
| MaxMosaicTiles | Integer | No | If empty, the server |
| | | | may render the |
| | | | viewing angles |
| | | | defined earlier in the |
| | | | session. |
| PTS | Integer | No | If empty, the server |
| | | | may effect the |
| | | | requested changes |
| | | | as soon as possible, |
| | | | and otherwise at the |
| | | | requested PTS |

### Signalling Minimum Viewing Angles and Spatial Resolution

In some examples, the client may wish to receive the video-based representation of the object shown at a higher spatial resolution than normally used by the server. For example, in the scene, the object may be located in between two PVRA's and the video stream(s) of the object may be generated by the server by synthesis from the PVRA's. If the path of movement of the viewing position passes from one PRVA to another while intermediately passing directly past the object, the object synthesized by the server may be at a too low spatial resolution given that the object may appear larger in the rendered view in-between the PRVA's than in the PRVA's themselves. The client may thus request a minimum spatial resolution for the transmission of the object's video data in a respective mosaic tile, and/or a minimum number of mosaic tiles to render, by the following signalling:

| Field | Type | Mandatory | Comments |
|---|---|---|---|
| SessionID | Integer | Yes | |
| ObjectID | Integer | Yes | |
| MinMosaicTileWidth | Integer | Yes | |
| MinMosaicTileHeight | Integer | Yes | |
| MinMosaicTiles | Integer | No | If empty, the server |
| | | | may render the |
| | | | viewing angles |
| | | | defined earlier in the |
| | | | session. |
| PTS | Integer | No | If empty, the server |
| | | | may effect the |
| | | | requested changes |
| | | | as soon as possible, |
| | | | and otherwise at the |
| | | | requested PTS. |

### Alternative Aspect Ratio

Preferably the video-based representations of the objects have a standard aspect ratio, such as a square aspect ratio, but in case of a very wide or tall object, it may be possible to diverge from the standard aspect ratio. The aspect ratio, and/or a deviation from the standard aspect ratio, may be signalled by the server to the client in accordance with the table titled ‘Communicating position of objects in space’ described elsewhere in this specification, in which the described signalling may be changed to include the ‘MosaicTileWidth’ and ‘MosaicTileHeight’ parameters. as defined below.

| Field | Type | Mandatory | Comments |
|---|---|---|---|
| SessionID | Integer | Yes | |
| RequestNumber | Integer | Yes | |
| StreamID | Text | Yes | Identifier of the |
| | | | stream containing |
| | | | the object. May be |
| | | | an URL or StreamID |
| | | | depending on how |
| | | | the information is |
| | | | streamed. |
| Position | Text | Yes | X, Y, Z |
| Orientation | Integer | Yes | May define the |
| | | | orientation of the |
| | | | object in the video |
| | | | stream(s) relatively |
| | | | to the north within |
| | | | the scene. |
| MosaicTileWidth | Integer | Yes | May be needed for |
| | | | the client to be able |
| | | | to split up the frame |
| | | | in the correct number |
| | | | of mosaic tiles. |
| MosaicTileHeight | Integer | Yes | May be needed for |
| | | | the client to be able |
| | | | to split up the frame |
| | | | in the correct number |
| | | | of mosaic tiles. |
| CenterAngle | Integer | No | |
| Range | Integer | No | May define the range |
| | | | of angles in degrees. |
| Scale | Decimal | Yes | |

### Alternative Arrangement Types

The object may be shown in the video stream(s) at the different viewing angles by using a spatial mosaic as previously described, e.g., with reference to FIG. 3. However, the different representations of the object may also be differently arranged in a spatial mosaic, or in general in a video frame, or across several video frames (e.g., of a same or of different video streams). As such, the type of video-based presentation may also be referred to as an arrangement type. For example, alternative spatial arrangements include, but are not limited to:
Top-down: the video-based representations of the object at the different viewing angles may be arranged from the top left to bottom left and from left to right.
Carousel: the video-based representations of the object at the different viewing angles may be arranged in one row next to each other.
Horizontal+Vertical: Here, next to each video-based representations of the object at a viewing angle on the horizontal axis of the object, the object may also be shown from at its vertical axis from above (e.g., +1) and below (e.g., −1). In such an arrangement, the angle corresponding to the vertical axis ‘+1’ angle may be specified as well as the angle of the vertical axis ‘−1’ angle.
Volumetric: Next to each video-based representation of the object at a viewing angle, there may be an image containing the depth information for the colour image, which image may for example either encode the depth as a single colour or grayscale gradient, for example from 0 to max. intensity, or by using the full colour gamut.
Custom: For each position in the video frame, information about the video-based representation of the object (for example: which object, which orientation, and what viewing angles) may be signalled.

In general, the projection type may be signalled as follows:

| Field | Type | Mandatory | Comments |
|---|---|---|---|
| SessionID | Integer | Yes | |
| ProjectionType | Text | Yes | May be “Regular”, |
| | | | “TopDown”, “Carousel”, |
| | | | “Horizontal + Vertical”, |
| | | | “Custom” |
| Message | Text | No | May be mandatory when |
| | | | ProjectionType = Custom |

In case of the projection type being ‘custom’, the following message may be included in the “Message” field:

| Field | Type | Mandatory | Comments |
|---|---|---|---|
| MosaicTileID | Integer | Yes | |
| MosaicTileDegree | Integer | Yes | For what viewing |
| | | | angle relatively to the |
| | | | object the mosaic tile |
| | | | is meant |
| PositionX | Integer | Yes | |
| PositionY | Integer | Yes | |

### Vertical Mosaic

The spatial mosaic explained so far may define the viewing angles under which an object may be viewed while moving on an X-Y plane of the scene, e.g., along a horizontal axis of the object. To be able to have true 6 DOF, or for other purposes, a spatial mosaic or the like may also show the object at different viewing angles along the vertical axis of the object, e.g., to allow movement in the Z-direction in the scene. This vertical range may be defined by ‘RangeVertical’ in the table below.

| Field | Type | Mandatory | Comments |
|---|---|---|---|
| SessionID | Integer | Yes | |
| RequestNumber | Integer | Yes | |
| StreamID | Text | Yes | Identifier of the |
| | | | stream containing |
| | | | the object. May be |
| | | | an URL or StreamID |
| | | | depending on how |
| | | | the information is |
| | | | streamed. |
| Position | Text | Yes | X, Y, Z |
| Orientation | Integer | Yes | May defines the |
| | | | orientation of the |
| | | | object in the video |
| | | | stream(s) relatively |
| | | | to the north within |
| | | | the scene. |
| NumberOfRows | Integer | Yes | May be needed for |
| | | | the client to be able |
| | | | to split up the frame |
| | | | in the correct |
| | | | number of mosaic |
| | | | tiles. |
| MosaicTilesPerRow | Integer | Yes | May be needed for |
| | | | the client to be able |
| | | | to split up the frame |
| | | | in the correct |
| | | | number of mosaic |
| | | | tiles. |
| CenterAngle | Integer | No | |
| RangeVertical | Integer | Yes | May define the range |
| | | | of angles in degrees |
| | | | along the object's |
| | | | vertical axis. |
| Scale | Decimal | Yes | |

As it may be less likely for the viewing position to move vertically within the scene, a vertical spatial mosaic may contain fewer spatial tiles than a horizontal spatial mosaic. It will be appreciated that a spatial mosaic may also simultaneously represent the object at different horizontal viewing angles and at different vertical viewing angles. Such a spatial mosaic has been previously described as a “Horizontal+Vertical” spatial arrangement.

### Mosaic Tiles Containing Volumetric Video

Normally the client device may receive image information for each viewing angle at which an object may be viewed. Especially for cases where the viewing position is very close to an object and/or the object has a complex shape (e.g., a statue), it may be beneficial to include depth information within the mosaic. Such depth information may for example allow the client to synthesize additional viewing angles of the object, or to adjust a video-based representation of an object to reflect a minor change in viewing angle. Including this depth information may comprise, but is not limited to, having the depth indicated per pixel in the form of a single-colour or grayscale gradient, for example running from zero intensity to maximum intensity. For this purpose, the arrangement type “volumetric” may be defined as previously elucidated. Additional information may be transmitted for volumetric content:

| Field | Type | Mandatory | Comments |
|---|---|---|---|
| SessionID | Integer | Yes | |
| RequestNumber | Integer | Yes | |
| StreamID | Text | Yes | Identifier of the stream |
| | | | containing the object. |
| | | | May be an URL or |
| | | | StreamID depending |
| | | | on how the |
| | | | information is |
| | | | streamed. |
| DepthRangeMin | Integer | Yes | Here the minimum |
| DepthRangeMax | Integer | Yes | and maximum |
| | | | distance may |
| | | | specified. Depending |
| | | | on the way the depth |
| | | | may be encoded (e.g., |
| | | | as grayscales or using |
| | | | the full colour gamut) |
| | | | the may granularity |
| | | | differ. Both |
| | | | parameters together |
| | | | may define the |
| | | | granularity of the |
| | | | depth. |

### Live Streaming Scenarios

While the video stream(s) may typically be streamed ‘on-demand’ by the server to the client, such video stream(s) may also be streamed live. There may be different ways of handling such live streaming scenarios, including but not limited to:
Best effort: The client may receive live streams containing PRVA's and may request additional content, for example the video-based representations of the object, in the manner defined elsewhere in this specification. The server may generate and send such video-based representations on a ‘best effort’ basis. This may work especially well for objects that do not or minorly or moderately change during playout and may result in artefacts for objects that significantly change. The best effort approach may preferably be used when the MTP latency is (very) low. In case of a best effort approach by the server, the PTS may not need to be communicated from the server to the client.
   Quality reduction: In case of the best effort approach, a reduction in video quality may also be used to reduce the MTP latency. Video quality may for example be reduced by reducing the spatial resolution or synthesizing less viewing angles.
Adding latency: Another way is to add latency to the video delivery pipeline. For example, when the MTP latency is 2 seconds, the live playout of the PRVA's by the client may be delayed by 2 seconds as well. This may enable the client to synchronize the live PRVA's with the synthesized video-based representations of the object at the different viewing angles.
Synthesize on the client: As described elsewhere in this specification, the client may also synthesize the object at the desired viewing angle(s) itself, for example if sufficient computational resources are available.

### Prediction of Future Viewing Positions

To keep the MTP latency low, the client may implement a prediction algorithm to predict future viewing positions. This way, video-based representations of the object at viewing angles which are suitable for future viewing positions may be generated in a timely manner. Such prediction may be any suitable kind of prediction, e.g., based on an extrapolation or model fitting of coordinates of current and past viewing positions, or more advanced predictions taking into account the nature of the application in which the scene is rendered. To allow the server to generate the desired viewing angles, it may be provided or otherwise determine the PTS and the future viewing position and viewing direction. The client may receive the synthesized video-based representations of the object and may place and render them accordingly. The signalling for this type of prediction may correspond to that described under the heading ‘client to server’ as described previously in this specification, except that the client may signal a PTS that is (far) in the future. The server may signal what frame number is associated with the requested viewing angles for the specific PTS, for example using signalling as described in the table titled ‘Communicating position of objects in space’. The client may associate the video frames with the PTS by using the ‘RequestID’ that may be signalled in the response from the server to the client.

### Synthesizing the Views by the Client

In certain cases, for example when the server is overloaded, the MTP latency is too high and/or the client is equipped with a sufficiently capable CPU and/or GPU, the client may locally synthesize viewing angles of the object. In such examples, it may suffice for the client to receive video-based representations of the object at a subset of the desired set of viewing angles. This subset may for example comprise the viewing angles of the object which are originally captured by the (omnidirectional) cameras, e.g., which are shown in the respective PRVAs, or any other number of viewing angles. The client may synthesize other desired viewing angles based on this subset. To indicate to the server that the client may itself synthesize certain viewing angles of the object, the client may for example set ‘MaxMosaicTiles’ to 2 in the message defined in the table titled ‘Signalling maximum viewing angles and spatial resolution’.

Signalling from Server to Client Regarding Overloading

After the client signals the server regarding its viewing position and possibly other information, the server may determine which number of viewing angles to synthesize. If the server is not capable of synthesizing this number of viewing angles, for example by having insufficient computational resources available (e.g., due to the server being ‘overloaded’), the server may send the following message:

| Field | Type | Mandatory | Comments |
|---|---|---|---|
| SessionID | Integer | Yes | |
| RequestNumber | Integer | Yes | |
| CurrentProcessingLoad | Integer | Yes | The percentage of |
| | | | CPU and/or GPU |
| | | | load |
| Message | Text | No | May give an |
| | | | additional message |
| | | | on its current state to |
| | | | be displayed on/by |
| | | | the client |
| MaxAngles | Integer | Yes | May indicate the |
| | | | number of viewing |
| | | | angels that can be |
| | | | synthesized on the |
| | | | server |

Object without PRVA

In many examples described in this specification, the client may receive a PRVA by streaming and video stream(s) of an object at different viewing angles. However, it is not needed for a client to render a scene based on PRVAs, for example when the scene is an augmented reality scene which only contains object(s) to be overlaid over an external environment, or in case the scene is partially defined by computer-graphics. In such examples, the MPD may not need to identify PRVA sources, and it may suffice to define only the layout of the scene. The client may use this layout to indicate its current viewing position and viewing direction to the server and to request video stream(s) of objects to be streamed to the client.

Deducing View Orientation from Tile Requests

It may not be needed for the client to signal its viewing direction to the server. For example, the server may estimate the viewing direction from requests sent by the client. For example, if the PRVAs are streamed to the client using tiled streaming (also known as ‘spatially segmented streaming’), the server may deduce the current viewing direction of the client device from the requests of the client for specific tiles. This way, the field ‘ViewingDirection’ in the message defined under the heading ‘client to server’ may be omitted.

With continued reference to the client device 100 of FIG. 1, it is noted that the network interface 120 of the client device 100 may for example be a wireless communication interface, which may also be referred to as a radio interface, and which may be configured to connect to a mobile network infrastructure. In some examples, the network interface 120 may comprise a radio and an antenna, or a radio and an antenna connection. In a specific example, the network interface 120 may be a 4G or 5G radio interface for connecting to a 4G or 5G mobile network adhering to one or more 3GPP standards, or a Wi-Fi communication interface for connecting to a Wi-Fi network infrastructure, etc. In other examples, the network interface 120 may be a wired communication interface, such as an Ethernet or fiber-optic based interface.

It is noted that the data communication between the client device 100 and the server system 200 may involve multiple networks. For example, the client device 100 may be connected via a radio access network to a mobile network's infrastructure and via the mobile infrastructure to the Internet, with the server system 200 being a server which is also connected to the Internet.

The client device 100 may further comprise a processor subsystem 140 which may be configured, e.g., by hardware design or software, to perform the operations described in this specification in as far as pertaining to the client device or the rendering of a scene. In general, the processor subsystem 140 may be embodied by a single Central Processing Unit (CPU), such as a x86 or ARM-based CPU, but also by a combination or system of such CPUs and/or other types of processing units, such as Graphics Processing Units (GPUs). The client device 100 may further comprise a display interface 180 for outputting display data 182 to a display 190. The display 190 may be an external display or an internal display of the client device 100, and in general may be head-mounted or non-head mounted. Using the display interface 180, the client device 100 may display the rendered scene. In some embodiments, the display 190 may comprise one or more sensors, such as accelerometers and/or gyroscopes, for example to detect a pose of the user. In such embodiments, the display 190 may provide sensor data 184 to the client device 100, for example via the aforementioned display interface 180 or via a separate interface. In other embodiments, such sensor data 184 may be received in separation of the display.

As also shown in FIG. 1, the client device 100 may comprise a data storage 160 for storing data, including but not limited to data defining the scene. The data storage 160 may take various forms, such as a hard drive or an array of hard drives, a solid-state drive or an array of solid-state drives, a memory, etc.

In general, the client device 100 may be embodied by a (single) device or apparatus, e.g., a smartphone, personal computer, laptop, tablet device, gaming console, set-top box, television, monitor, projector, smart watch, smart glasses, media player, media recorder, etc. In some examples, the client device 100 may be a so-called User Equipment (UE) of a mobile telecommunication network, such as a 5G or next-gen mobile network. In other examples, the client device may be an edge node of a network, such as an edge node of the aforementioned mobile telecommunication. In such examples, the client device may lack a display output, or at least may not use the display output to display the rendered scene. Rather, the client device may render the scene, which may then be made available for streaming to a further downstream client device, such as an end-user device.

With continued reference to the server system 200 of FIG. 1, it is noted that the network interface 220 of the server system 200 may for example be a wired communication interface, such as an Ethernet or fiber-optic based interface. The network 10 may for example be the Internet or a mobile network, with the server system 200 being connected to a fixed part of the mobile network. Alternatively, the network interface 220 may be a wireless communication interface, e.g., being of a type as described above for the client device 100.

The server system 200 may further comprise a processor subsystem 240 which may be configured, e.g., by hardware design or software, to perform the operations described in this specification in as far as pertaining to a server system or in general to the generating of one or more video streams to show an object from a limited set of viewing angles. In general, the processor subsystem 240 may be embodied by a single CPU, such as a x86 or ARM-based CPU, but also by a combination or system of such CPUs and/or other types of processing units, such as GPUs. In embodiments where the server system 200 is distributed over different entities, e.g., over different servers, the processor subsystem 240 may also be distributed, e.g., over the CPUs and/or GPUs of such different servers. As also shown in FIG. 1, the server system 200 may comprise a data storage 260, such as a hard drive or an array of hard drives, a solid-state drive or an array of solid-state drives, a memory, etc., which may be used to store data, including but not limited to video data of the scene or specifically of the object to be streamed to the client device.

The server system 200 may be distributed over various entities, such as local or remote servers. In some embodiments, the server system 200 may be implemented by a type of server or a system of such servers. For example, the server system 200 may be implemented by one or more cloud servers or by one or more edge nodes of a mobile network. In some embodiments, the server system 200 and the client device 100 may mutually cooperate in accordance with a client-server model, in which the client device 100 acts as client.

In general, each entity described in this specification may be embodied as, or in, a device or apparatus. The device or apparatus may comprise one or more (micro) processors which execute appropriate software. The processor(s) of a respective entity may be embodied by one or more of these (micro) processors. Software implementing the functionality of a respective entity may have been downloaded and/or stored in a corresponding memory or memories, e.g., in volatile memory such as RAM or in non-volatile memory such as Flash. Alternatively, the processor(s) of a respective entity may be implemented in the device or apparatus in the form of programmable logic, e.g., as a Field-Programmable Gate Array (FPGA). Any input and/or output interfaces may be implemented by respective interfaces of the device or apparatus. In general, each functional unit of a respective entity may be implemented in the form of a circuit or circuitry. A respective entity may also be implemented in a distributed manner, e.g., involving different devices or apparatus.

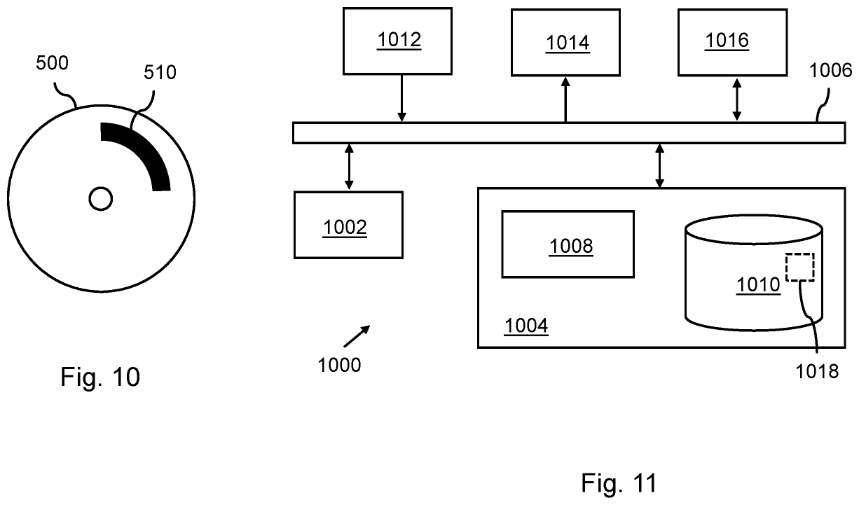

It is noted that any of the methods described in this specification, for example in any of the claims, may be implemented on a computer as a computer implemented method, as dedicated hardware, or as a combination of both. Instructions for the computer, e.g., executable code, may be stored on a computer-readable medium 500 as for example shown in FIG. 10, e.g., in the form of a series 510 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 10 shows by way of example an optical storage device 500.

In an alternative embodiment of the computer-readable medium 500, the computer-readable medium 500 may comprise transitory or non-transitory data 510 in the form of a data structure representing metadata described in this specification.

FIG. 11 is a block diagram illustrating an exemplary data processing system 1000 that may be used in the embodiments described in this specification. Such data processing systems include data processing entities described in this specification, including but not limited to the server system and the client device.

The data processing system 1000 may include at least one processor 1002 coupled to memory elements 1004 through a system bus 1006. As such, the data processing system may store program code within memory elements 1004. Furthermore, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification.

The memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The data processing system 1000 may also include one or more cache memories (not shown) that provide temporary storage of at least some program code in order to reduce the number of times program code is otherwise retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 1000.

As shown in FIG. 11, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail. For example, data processing system 1000 may represent a server system as described with reference to FIG. 1 and elsewhere in this specification. In that case, application 1018 may represent an application that, when executed, configures data processing system 1000 to perform the functions described with reference to the server system. In another example, data processing system 1000 may represent a client device as described with reference to FIG. 1 and elsewhere in this specification. In that case, application 1018 may represent an application that, when executed, configures data processing system 1000 to perform the functions described with reference to the client device.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A computer-implemented method of enabling a client device to render a three-dimensional [3D] scene comprising one or more objects, comprising:
at a server system, streaming a video-based representation of an object as one or more video streams to the client device;
at the client device, rendering the scene from a viewing position within the scene to obtain a rendered view of the scene, wherein the rendering of the scene comprises placing the video-based representation of the object at an object position within the scene;
wherein the method further comprises:
at the server system or at the client device, determining a relative position between the viewing position and the object position, wherein the relative position is representable as a direction and a distance between the viewing position and the object position;
at the server system, generating the one or more video streams to show the object from a limited set of viewing angles which is limited to a set of angles within an interval, wherein the interval is within a range of possible angles from which the object can be rendered, and wherein the limited set of viewing angles is selected based on the relative position such that the viewing angle which geometrically corresponds to the direction to the object is included within the interval; and
at the client device, when changing the viewing position and the relative position, selecting a viewing angle from the limited set of viewing angles that corresponds to the changed relative position, and placing the video-based representation of the object in accordance with said selected viewing angle in the scene.

2. The method according to claim 1, wherein the limited set of viewing angles is further selected based on the distance.

3. The method according to claim 1, wherein at least one of: a width of the interval, a number of viewing angles within the interval, and a spacing of the viewing angles within the interval, is selected based on the distance.

4. The method according to claim 1, further comprising, at the server system, adjusting a spatial resolution, a temporal framerate, or another video quality parameter of the one or more video streams based on the distance.

5. The method according to claim 1, further comprising estimating a latency associated with the streaming of the one or more video streams from the server system to the client device, wherein the limited set of angles is selected further based on the latency.

6. The method according to claim 1, further comprising, at the client device, moving the viewing position within the scene over time, wherein the limited set of angles is selected based on a prediction of a change in the relative position due to said movement of the viewing position.

7. The method according to claim 6, wherein the movement of the viewing position is planned to follow a path to a next viewing position in the scene, wherein the limited set of viewing angles is selected based on the next viewing position or an intermediate viewing position along the path to the next viewing position.

8. The method according to claim 1, further comprising:
at the server system, streaming a panoramic video to the client device to serve as a video-based representation of at least part of the scene;
at the client device, rendering the panoramic video as a background to the video-based representation of the object.

9. The method according to claim 8, wherein the panoramic video comprises presentation timestamps, wherein the method further comprises:
at the client device, providing a presentation timestamp to the server system during playout of the panoramic video;
at the server system, generating the one or more video streams to show the object at a temporal state which is determined based on the presentation timestamp.

10. The method according to claim 1, further comprising, at the client device:
rendering the scene within a viewport, wherein the viewport is defined by a viewing direction and/or a field of view;
providing metadata to the server system, wherein the metadata is indicative of the viewing direction and/or the field of view;
and at the server system:
determining a visibility of the object at the client device based on the metadata and controlling the streaming of the one or more video streams based on the visibility.

11. The method according to claim 1, wherein generating the one or more video streams comprises generating the one or more video streams to include a set of videos, wherein each of the videos shows the object from a different viewing angle.

12. The method according to claim 11, wherein generating the one or more video streams comprises at least one of:
spatially multiplexing the set of videos;
temporally multiplexing the set of videos; and
using a multi-view coding technique to encode the set of videos.

13. A non-transitory computer-readable medium comprising data representing a computer program, the computer program comprising instructions for causing a processor system to perform the method according to claim 1.

14. A client device configured to render a three-dimensional [3D] scene comprising one or more objects, comprising:
a network interface to a network;
a processor subsystem configured to:
from a streaming system and via the network, receive one or more video streams comprising a video-based representation of an object;
render the scene from a viewing position within the scene to obtain a rendered view of the scene, wherein the rendering of the scene comprises placing the video-based representation of the object at an object position within the scene;
wherein the processor subsystem is further configured to:
determine a relative position between the viewing position and the object position;
provide metadata indicative of the relative position to the server system to cause the server system to generate the one or more video streams to show the object from a limited set of viewing angles, wherein the limited set of viewing angles is selected based on the relative position; and
select a viewing angle from the limited set of viewing angles and place the video-based representation of the object in accordance with said selected viewing angle in the scene.

15. A server system for streaming a video-based representation of an object as one or more video streams to a client device, wherein the client device is configured to render the object as part of a three-dimensional [3D] scene, comprising:
a network interface to a network;
a processor subsystem configured to:
determine a relative position between a viewing position, from which viewing position the client device renders the scene, and an object position, at which object position the video-based representation of the object is placed within the scene; and
generate the one or more video streams to show the object from a limited set of viewing angles, wherein the limited set of viewing angles is selected based on the relative position.

16. The server system according to claim 15, wherein the processor subsystem is configured to receive metadata from the client device comprising at least one of: the viewing position, the object position and the relative position.

17. The server system according to claim 15, wherein the processor subsystem is configured to generate one or more visual representations of the object to show the object at different viewing angles by at least one of:
rendering a 3D graphics-based object from the different viewing angles;
synthesizing the one or more visual representations of the object from at least one other visual representation of the object.
